(19) United States
(12) Patent Application Publication
(10) Pub. No.: US 2025/0205022 A1
(43) Pub. Date: Jun. 26, 2025

(54) DENTAL IMPLANTS WITH VARYING DIAMETERS AND THREAD TYPES

(71) Applicant: RTG Scientific, LLC, Austin, TX (US)

(72) Inventors: Richard Justin HYER, Hyrum, UT (US); Andrew R. FAUTH, North Logan, UT (US); Quinten C. KUNZ, Richmond, VA (US)

(21) Appl. No.: 19/002,596

(22) Filed: Dec. 26, 2024

Related U.S. Application Data
(60) Provisional application No. 63/614,878, filed on Dec. 26, 2023.
(60) Provisional application No. 63/569,174, filed on Mar. 24, 2024.

(51) Int. Cl. A61C 8/00

(52) U.S. Cl. CPC A61C 8/0072; A61C 8/0024; A61C 8/0074

(57) ABSTRACT

A threaded dental implant may include a fastener body defining a longitudinal axis. The fastener body may include a proximal end including an internal pocket configured to receive a dental component and a distal end. The fastener body may further include a helical thread disposed about the fastener body and extending along the longitudinal axis, the helical thread having a major thread diameter, a minor thread diameter, a distal-facing side and a proximal-facing side. The minor thread diameter may be tapered such that the minor thread diameter is smaller at the distal end than at the proximal end and the helical thread may include a first thread form comprising a generally concave side.

### CROSS-REFERENCE TO RELATED APPLICATIONS

This application claims the benefit of U.S. Provisional Patent Application Ser. No. 63/614,878 filed on Dec. 26, 2023, entitled “DENTAL IMPLANTS WITH VARYING DIAMETERS AND THREAD TYPES”. This application also claims the benefit of U.S. Provisional Patent Application Ser. No. 63/569,174 filed on Mar. 24, 2024, entitled “ENHANCED SYSTEMS AND METHODS FOR MANUFACTURING UNDERCUT FASTENER THREADFORMS”. The foregoing documents are hereby incorporated by reference in their entirety.

### TECHNICAL FIELD

The present disclosure relates to threaded dental implants. More specifically, the present disclosure relates to dental implants with varying diameters and thread types.

### BACKGROUND

Modern dental implants are typically designed to integrate with the jawbone through a process known as osseointegration, which ensures long-term stability and durability. Threaded dental implants are among the most commonly used designs due to their ability to provide mechanical stability during initial placement and to promote favorable load distribution to the surrounding bone tissue.

The threads on dental implants play a critical role in their performance. Traditional thread forms often focus on maximizing primary stability by engaging the bone during placement. However, these designs may generate excessive stresses in the bone, leading to micro-damage, bone resorption, or delayed healing. Furthermore, conventional thread shapes may not optimize stress distribution during the functional loading phase, potentially contributing to implant failure.

Accordingly, dental implants with improved thread and compression designs for increasing bone fixation and load sharing between a bone/fastener interface experiencing multi-axial and off-loading conditions would be desirable.

### SUMMARY

The various bone fixation devices, systems, and methods of the present disclosure have been developed in response to the present state of the art, and in particular, in response to the problems and needs in the art that have not yet been fully solved by currently available bone fixation devices, systems, and methods. In some embodiments, the bone fixation devices, systems, and methods of the present disclosure may provide improved bone fixation and load sharing between a bone/fastener interface under multi-axial and off-loading conditions.

In some embodiments, a threaded dental implant may include a fastener body defining a longitudinal axis. The fastener body may include a proximal end including an internal pocket configured to receive a dental component and a distal end. The fastener body may further include a helical thread disposed about the fastener body and extending along the longitudinal axis, the helical thread having a major thread diameter, a minor thread diameter, a distal-facing side and a proximal-facing side. The minor thread diameter may be tapered such that the minor thread diameter is smaller at the distal end than at the proximal end and the helical thread may include a first thread form comprising a generally concave side.

In the threaded dental implant of any preceding paragraph, the distal-facing side may be generally concave and the proximal-facing side may be generally convex.

In the threaded dental implant of any preceding paragraph, the major thread diameter may be tapered such that the major thread diameter may be smaller at the distal end than at the proximal end.

In the threaded dental implant of any preceding paragraph, a first portion of the helical thread, proximate the proximal end, may include the major thread diameter that is generally constant and the minor thread diameter that is generally constant.

In the threaded dental implant of any preceding paragraph, the first portion of the helical thread, proximate the proximal end, may include a second thread form lacking the generally concave side.

In the threaded dental implant of any preceding paragraph, the first portion of the helical thread, proximate the proximal end, may include the first thread form and a second portion of the helical thread, proximate the distal end, may include a second thread form that is generally equal to the first thread form.

In the threaded dental implant of any preceding paragraph, the fastener body may include a cutting flute extending from the distal end to the proximal end.

In the threaded dental implant of any preceding paragraph, the helical thread may extend from the distal end to the proximal end.

In the threaded dental implant of any preceding paragraph, the fastener body may include a tapered lead-in portion proximate the distal end.

In the threaded dental implant of any preceding paragraph, the tapered lead-in portion may lack the helical thread.

In the threaded dental implant of any preceding paragraph, the tapered lead-in portion may include a second thread form lacking the generally concave side.

In the threaded dental implant of any preceding paragraph, the proximal end may include a threaded socket configured to receive the dental component.

In the threaded dental implant of any preceding paragraph, the distal portion may include a second helical thread having a thread form lacking a concave side and the proximal portion may include a third helical thread having a micro-thread form.

In some embodiments, a threaded dental implant may include a fastener body defining a longitudinal axis. The fastener body may include a proximal end having an internal pocket configured to receive a dental component, a distal end, a first portion having a first helical thread disposed about the first portion along the longitudinal axis and having a first thread form, and a second portion having a second helical thread disposed about the second portion along the longitudinal axis and having a second thread form. The first thread form may include a distal-facing side that is generally concave and a proximal-facing side that is generally convex and the second thread form may lack a generally concave side.

In the threaded dental implant of any preceding paragraph, the second helical thread may include a major thread diameter and a minor thread diameter that is tapered.

In the threaded dental implant of any preceding paragraph, the first helical thread may include a major thread diameter that is generally constant and a minor thread diameter that is generally constant.

In the threaded dental implant of any preceding paragraph, the second portion may further include a tapered lead-in portion comprising the second thread form.

In the threaded dental implant of any preceding paragraph, the fastener body may further include a third portion, proximate the proximal end, having a third helical thread disposed about the third portion along the longitudinal axis and having a third thread form lacking the generally concave side.

In the threaded dental implant of any preceding paragraph, the third thread form is a micro-thread form.

In some embodiments, a threaded dental implant may include a fastener body defining a longitudinal axis. The fastener body may include a proximal end having an internal pocket configured to receive a dental component, a distal end, a first portion having a first helical thread disposed about the first portion along the longitudinal axis and having a first thread form, a second portion having a second helical thread disposed about the second portion along the longitudinal axis and having a second thread form, and a cutting flute that may extend from the distal end to the proximal end. At least one of the first thread form and the second thread form may include a distal-facing side that is generally concave and a proximal-facing side that is generally convex.

In the threaded dental implant of any preceding paragraph, the first helical thread may include a first major thread diameter that is generally constant and a first minor thread diameter that is generally constant; and the second helical thread may include a second major thread diameter and a second minor thread diameter that is tapered.

In the threaded dental implant of any preceding paragraph, the second portion may extend from the first portion to the distal end, and may include the second thread form having the distal-facing side that is generally concave and the proximal-facing side that is generally convex.

These and other features and advantages of the present disclosure will become more fully apparent from the following description and appended claims or may be learned by the practice of the bone fixation devices, systems, and methods set forth hereinafter.

### BRIEF DESCRIPTION OF THE DRAWINGS

Exemplary embodiments of the present disclosure will become more fully apparent from the following description taken in conjunction with the accompanying drawings.

Understanding that these drawings depict only exemplary embodiments and are, therefore, not to be considered limiting of the scope of the present disclosure, the exemplary embodiments of the present disclosure will be described with additional specificity and detail through use of the accompanying drawings in which:

FIG. 1A is a front perspective view of a fastener according to an embodiment of the present disclosure.

FIG. 1B is a rear perspective view of the fastener of FIG. 1A.

FIG. 1C is a side view of the fastener of FIG. 1A.

FIG. 1D is a cross-sectional side view of the fastener of FIG. 1C, taken along the line A-A.

FIG. 2 is a partial cross-sectional side view of a fastener according to an embodiment of the present disclosure.

FIG. 3A is a side view of a fastener body according to an embodiment of the present disclosure.

FIG. 3B is a cross-sectional side view of the fastener body of FIG. 3A.

FIG. 3C is a cross-sectional side view of the fastener body of FIG. 3A.

FIG. 4A is a side view of a fastener body according to an embodiment of the present disclosure.

FIG. 4B is a cross-sectional side view of the fastener body of FIG. 4A.

FIG. 5A is a side view of a fastener body according to an embodiment of the present disclosure.

FIG. 5B is a cross-sectional side view of the fastener body of FIG. 5A.

FIG. 6A is a side view of a fastener body according to an embodiment of the present disclosure.

FIG. 6B is a cross-sectional side view of the fastener body of FIG. 6A.

FIG. 7A is a side view of a fastener body according to an embodiment of the present disclosure.

FIG. 7B is a cross-sectional side view of the fastener body of FIG. 7A.

FIG. 8A is a side view of a fastener body according to an embodiment of the present disclosure.

FIG. 8B is a cross-sectional side view of the fastener body of FIG. 8A.

FIG. 9A is a side view of a fastener body according to an embodiment of the present disclosure.

FIG. 9B is a cross-sectional side view of the fastener body of FIG. 9A.

FIG. 10A is a side view of a fastener body according to an embodiment of the present disclosure.

FIG. 10B is a cross-sectional side view of the fastener body of FIG. 10A.

FIG. 11A is a side view of a fastener body according to an embodiment of the present disclosure.

FIG. 11B is a cross-sectional side view of the fastener body of FIG. 11A.

FIG. 12A is a side view of a fastener body according to an embodiment of the present disclosure.

FIG. 12B is a cross-sectional side view of the fastener body of FIG. 12A.

FIG. 13 is a side view of a fastener body according to an embodiment of the present disclosure.

FIG. 14 is a side view of a fastener body according to an embodiment of the present disclosure.

FIG. 15A is a perspective view of an abutment according to an embodiment of the present disclosure.

FIG. 15B is a side view of the abutment of FIG. 15A.

FIG. 16A is a perspective view of an abutment according to an embodiment of the present disclosure.

FIG. 16B is a side view of the abutment of FIG. 16A.

FIG. 17A is an exploded perspective view of a fastener body assembled and an abutment according to an embodiment of the present disclosure.

FIG. 17B is a side view of the fastener body assembled with the abutment of FIG. 17A.

FIG. 18A is a perspective view of a fastener body assembled with a dental crown according to an embodiment of the present disclosure.

FIG. 18B is a side view of the fastener body assembled with the dental crown of FIG. 18A.

It is to be understood that the drawings are for purposes of illustrating the concepts of the present disclosure and may not be drawn to scale. Furthermore, the drawings illustrate exemplary embodiments and do not represent limitations to the scope of the present disclosure.

### DETAILED DESCRIPTION

Exemplary embodiments of the present disclosure will be best understood by reference to the drawings, wherein like parts are designated by like numerals throughout. It will be readily understood that the components of the present disclosure, as generally described and illustrated in the drawings, could be arranged, and designed in a wide variety of different configurations. Thus, the following more detailed description of the embodiments of the devices, systems, and methods, as represented in the drawings, is not intended to limit the scope of the present disclosure but is merely representative of exemplary embodiments of the present disclosure.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in the drawings, the drawings are not necessarily drawn to scale unless specifically indicated.

Standard medical planes of reference and descriptive terminology are employed in this specification. While these terms are commonly used to refer to the human body, certain terms are applicable to physical objects in general.

A standard system of three mutually perpendicular reference planes is employed. A sagittal plane divides a body into right and left portions. A coronal plane divides a body into anterior and posterior portions. A transverse plane divides a body into superior and inferior portions. A mid-sagittal, mid-coronal, or mid-transverse plane divides a body into equal portions, which may be bilaterally symmetric. The intersection of the sagittal and coronal planes defines a superior-inferior or cephalad-caudal axis. The intersection of the sagittal and transverse planes defines an anterior-posterior axis. The intersection of the coronal and transverse planes defines a medial-lateral axis. The superior-inferior or cephalad-caudal axis, the anterior-posterior axis, and the medial-lateral axis are mutually perpendicular.

Anterior means toward the front of a body. Posterior means toward the back of a body. Superior or cephalad means toward the head. Inferior or caudal means toward the feet or tail. Medial means toward the midline of a body, particularly toward a plane of bilateral symmetry of the body. Lateral means away from the midline of a body or away from a plane of bilateral symmetry of the body. Axial means toward a central axis of a body. Abaxial means away from a central axis of a body. Ipsilateral means on the same side of the body. Contralateral means on the opposite side of the body. Proximal means toward the trunk of the body. Proximal may also mean toward a user or operator. Distal means away from the trunk. Distal may also mean away from a user or operator. Dorsal means toward the top of the foot. Plantar means toward the sole of the foot. Varus means deviation of the distal part of the leg below the knee inward, resulting in a bowlegged appearance. Valgus means deviation of the distal part of the leg below the knee outward, resulting in a knock-kneed appearance.

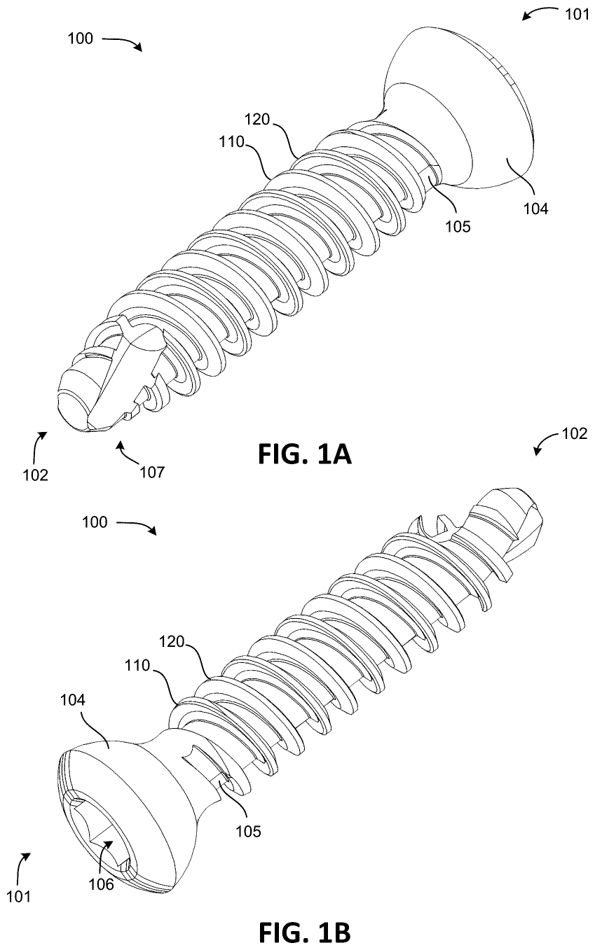

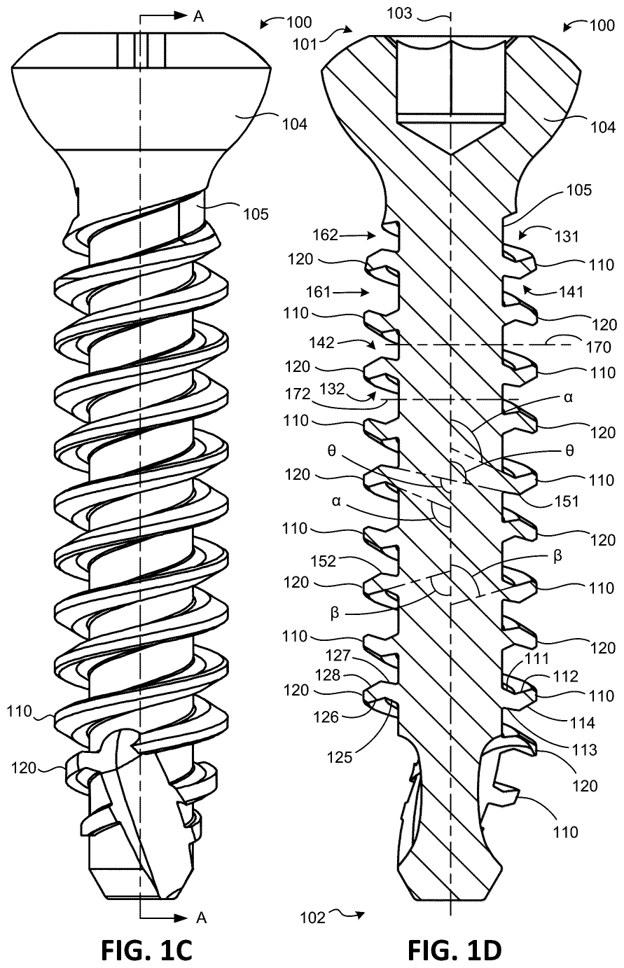

FIGS. 1A-1D are various views of a bone screw, bone implant, implantable bone anchor, bone disunion fastener, and/or fastener 100, according to an example of the present disclosure. Specifically, FIG. 1A is a front perspective view of a fastener 100 according to an embodiment of the present disclosure. FIG. 1B is a rear perspective view of the fastener 100, FIG. 1C is a side view of the fastener 100, and FIG. 1D is a cross-sectional side view of the fastener of FIG. 1C, taken along the line A-A.

The fastener 100 may be configured to stabilize disunions between two or more adjacent bones and/or bone portions, such as bone joints, bone fractures, bone abutments, etc. Additionally, or alternatively, the fastener 100 may be configured to secure a second implant (for example: a plate, a rod, a washer, and/or another implant) to a bone.

In general, the fastener 100 may include a shaft 105 having a proximal end 101, a distal end 102, and a longitudinal axis 103. The fastener 100 may also include a head 104 located at the proximal end 101 of the shaft 105, a torque connection interface 106 formed in/on the head 104 (in either a male/female configuration), and a self-tapping feature 107 formed in the distal end 102 of the shaft 105.

The fastener 100 may include a first helical thread 110 disposed about the shaft 105, and a second helical thread 120 disposed about the shaft 105 adjacent the first helical thread 110. The fastener 100 may include a “dual start” or “dual-lead” thread configuration comprising the first helical thread 110 and the second helical thread 120. A depth of the first helical thread 110 and/or the second helical thread 120 with respect to the shaft 105 may define a major diameter vs. a minor diameter of the shaft 105 alone.

In some embodiments, a major diameter and/or a minor diameter of the fastener 100 may be constant or substantially constant along the entire length of the fastener, or along a majority of the length of the fastener 100. In these embodiments, a constant minor diameter may help avoid blowout of narrow/delicate bones (e.g., a pedicle) when inserting the fastener 100 into a bone. A pilot hole may first be drilled into a narrow/delicate bone and then the fastener 100, having a similar minor diameter in comparison to the diameter of the pilot hole, may be chosen to avoid blowout when inserting the fastener 100 into the bone, as will be discussed in more detail below.

Additionally, or alternatively, a depth of the first helical thread 110 and/or the second helical thread 120 with respect to the shaft 105 may vary along a length of the shaft 105 to define one or more major diameters of the fastener 100 and/or one or more regions along the fastener 100 may include one or more continuously variable major diameters.

A thickness of the shaft 105 may vary along a length of the shaft 105 to define one or more minor diameters of the fastener 100, and/or one or more regions along the fastener 100 may include one or more continuously variable minor diameters.

A thickness/height/width/length/pitch/angle/shape, etc., of the first helical thread 110 and/or the second helical thread 120 (or any additional helical thread) may vary along a length of the shaft 105. For example, a thickness/height/width/length/pitch/angle/shape, etc., of the first helical thread 110 and/or the second helical thread 120 may be greater towards the distal end 102 of the fastener 100 and thinner towards the head 104 of the fastener 100 (or vice versa) in either a discrete or continuously variable fashion, etc.

The major diameter and/or minor diameter may increase toward a proximal end 101 or head 104 of a fastener 100 in order to increase bone compaction as the fastener 100 is terminally inserted into the bone/tissue.

A pitch of the first helical thread 110 and/or the second helical thread 120 may vary along a length of the fastener 100. The fastener 100 may include a plurality of helical threads disposed about the shaft 105. However, it will also be understood that any of the fasteners disclosed or contemplated herein may include a single helical thread disposed about the shaft of the fastener. Moreover, the fastener 100 may include a nested plurality of helical threads having different lengths (not shown). As one non-limiting example, the fastener 100 may include a first helical thread 110 that is longer than a second helical thread 120, such that the fastener 100 comprises dual threading along a first portion of the shaft 105 and single threading along a second portion of the shaft 105.

In some embodiments, the plurality of helical threads may include three helical threads comprising a “triple start” or “triple lead” thread configuration (not shown).

In some embodiments, the plurality of helical threads may include four helical threads comprising a “quadruple start” or “quadruple lead” thread configuration (not shown).

In some embodiments, the plurality of helical threads may include more than four helical threads (not shown).

In some embodiments, the fastener 100 may include first threading with any of the shapes disclosed herein oriented toward one of the proximal end 101 and the distal end 102 of the fastener 100, with the first threading located proximate the distal end 102 of the fastener 100, as well as second threading with any of the shapes disclosed herein oriented toward the other one of the proximal end 101 and the distal end 102 of the fastener 100, with the second threading located proximate the head 104 of the fastener 100 (not shown).

The fastener 100 may include multiple threading (e.g., dual helical threading, etc.) with any of the shapes disclosed herein located proximate one of the proximal end 101 and the distal end 102 of the fastener 100, as well as single threading with any of the shapes disclosed herein with the second threading located proximate the other of the proximal end 101 and the distal end 102 of the fastener 100.

The first helical thread 110 may include a plurality of first concave undercut surfaces 131 and a plurality of first convex undercut surfaces 141. The second helical thread 120 may include a plurality of second concave undercut surfaces 132 and a plurality of second convex undercut surfaces 142.

In some embodiments, when the fastener 100 is viewed in section along a plane that intersects the longitudinal axis 103 of the shaft 105 (e.g., see FIG. 1D), the plurality of first concave undercut surfaces 131 and the plurality of second convex undercut surfaces 142 may be oriented toward (i.e., point toward) the proximal end 101 of the fastener 100. Additionally, the plurality of first convex undercut surfaces 141 and the plurality of second concave undercut surfaces 132 may be oriented toward (i.e., point toward) the distal end 102 of the fastener 100.

In some embodiments, at least one of the plurality of first concave undercut surfaces 131, the plurality of first convex undercut surfaces 141, the plurality of second concave undercut surfaces 132, and the plurality of second convex undercut surfaces 142 may comprise at least one substantially flat surface.

When the fastener 100 is viewed in section along a plane intersecting the longitudinal axis 103 of the shaft 105, the first helical thread 110 may include a plurality of first bent shapes (comprising at least one surface that is angled relative to the longitudinal axis 103 of the shaft 105 and/or at least one undercut surface) with a plurality of first intermediate portions 151 that are oriented toward (i.e., point toward) the distal end 102 of the fastener 100. This may be referred to as “conventional” threading, or having a “conventional” orientation.

When the fastener 100 is viewed in section along a plane intersecting the longitudinal axis 103 of the shaft 105, the second helical thread 120 may comprise a plurality of second bent shapes (comprising at least one surface that is angled relative to the longitudinal axis 103 of the shaft 105 and/or at least one undercut surface) with a plurality of second intermediate portions 152 that are oriented toward (i.e., point toward) the proximal end 101 of the fastener 100. This may be referred to as “inverted” threading, or having an “inverted” orientation, or an “undercut thread”.

In some embodiments, one or more helical threads may morph/transition between a conventional orientation and an inverted orientation along a shaft of a fastener 100.

In some embodiments, at least one of the plurality of first concave undercut surfaces 131, the plurality of first convex undercut surfaces 141, the plurality of second concave undercut surfaces 132, and the plurality of second convex undercut surfaces 142 may include at least one curved surface.

As shown in FIG. 1D, the proximally-oriented and distally-oriented surfaces of the first helical thread 110 (i.e., the first concave undercut surfaces 131 and the first convex undercut surfaces 141 in the fastener 100 of FIG. 1D) may not have mirror symmetry relative to each other about any plane perpendicular to the longitudinal axis 103 of the fastener 100. Rather, the first concave undercut surfaces 131 may be offset from the first convex undercut surfaces 141.

The same may be true for the second helical thread 120, in which the second concave undercut surfaces 132 and the second convex undercut surfaces 142 may not have mirror symmetry relative to each other about any plane perpendicular to the longitudinal axis 103 of the fastener 100.

Conversely, as also shown in FIG. 1D, the proximally-oriented surfaces of the first helical thread 110 may have mirror symmetry relative to the distally-oriented surfaces of the second helical thread 120. Specifically, the first concave undercut surfaces 131 may have mirror symmetry relative to the second convex undercut surfaces 142 about a plane 170 that bisects the space between them and lies perpendicular to the longitudinal axis 103.

Similarly, the distally-oriented surfaces of the first helical thread 110 may have mirror symmetry relative to the proximally-oriented surfaces of the second helical thread 120. Specifically, the second concave undercut surfaces 132 may have mirror symmetry relative to the first convex undercut surfaces 141 about a plane 172 that bisects the space between them and lies perpendicular to the longitudinal axis 103.

This mirror symmetry may be present along most of the length of the first helical thread 110 and the second helical thread 120, with symmetry across different planes arranged between adjacent turns of the first helical thread 110 and the second helical thread 120 along the length of the longitudinal axis 103. Such mirror symmetry may help more effectively capture bone between the first helical thread 110 and the second helical thread 120 and may also facilitate manufacture of the fastener 100.

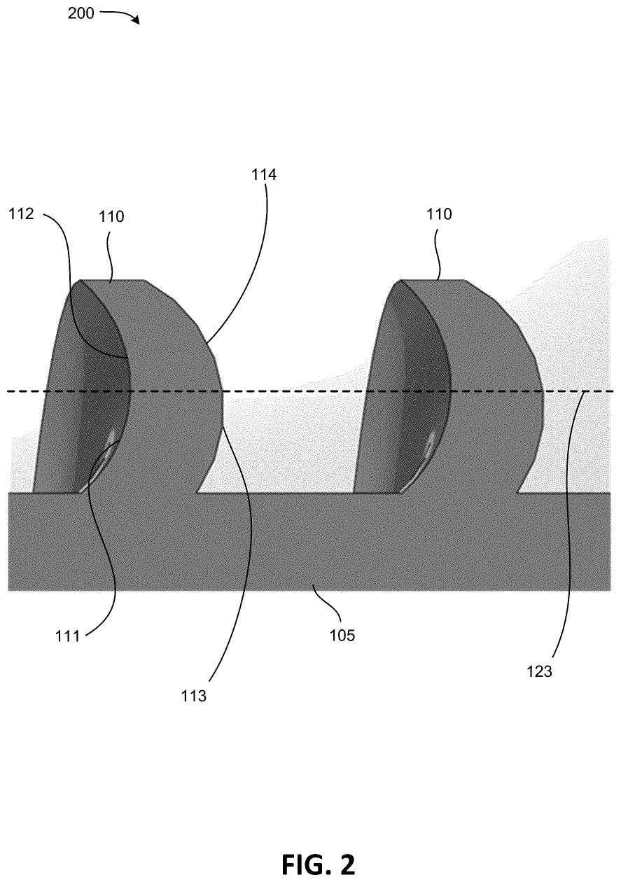

In some embodiments, when the fastener 100 is viewed in section along a plane intersecting the longitudinal axis 103 of the shaft 105, the first helical thread 110 may include at least one partial crescent shape that is oriented toward (i.e., points toward) the distal end 102 of the shaft 105 and/or the proximal end 101 of the shaft 105. FIG. 2 illustrates a partial cross-sectional view of a fastener 200 comprising crescent shapes, as one non-limiting example of such an embodiment.

In some embodiments (not shown), when the fastener 100 is viewed in section along a plane intersecting the longitudinal axis 103 of the shaft 105, the first helical thread 110 may include at least one partial crescent shape that is oriented toward (i.e., points toward) the distal end 102 of the shaft 105, and the second helical thread 120 may include at least one partial crescent shape that is oriented toward (i.e., points toward) the proximal end 101 of the shaft 105.

In some embodiments (not shown), the first helical thread 110 may include a first plurality of partial crescent shapes that are oriented toward (i.e., point toward) the distal end 102 of the shaft 105, and the second helical thread 120 may include a second plurality of partial crescent shapes that are oriented toward (i.e., point toward) the proximal end 101 of the shaft 105.

In some embodiments (not shown), the first plurality of partial crescent shapes and the second plurality of partial crescent shapes may be arranged in alternating succession along the shaft 105 of the fastener 100.

In some embodiments, the first helical thread 110 may be bisected by the line 123 shown in FIG. 2 with each crescent shape including a plurality of first undercut surfaces 111, a plurality of second undercut surfaces 112, a plurality of third undercut surfaces 113, and a plurality of fourth open surfaces 114 similar to the helical threading shown in FIG. 1D, except with curved surfaces in place of flat surfaces.

The plurality of first undercut surfaces 111 and the plurality of second undercut surfaces 112 may comprise concave curved surfaces. However, it will be understood that portions of the plurality of first undercut surfaces 111 and/or portions of the plurality of second undercut surfaces 112 may also comprise convex curved surfaces and/or flat surfaces (not shown in FIG. 2).

The plurality of third undercut surfaces 113 and the plurality of fourth open surfaces 114 may comprise convex curved surfaces. However, it will be understood that portions of the plurality of third undercut surfaces 113 and the plurality of fourth open surfaces 114 may also comprise concave curved surfaces and/or flat surfaces (not shown in FIG. 2).

The plurality of third undercut surfaces 113 and the plurality of fourth open surfaces 114 may be replaced by a ramped surface (such as that utilized in a conventional buttress thread design) without any undercuts (not shown in FIG. 2). Likewise, any of the other thread designs disclosed herein may utilize a ramped or buttress thread design on at least one side of the helical thread.

In some embodiments, a fastener may have only conventional threads or only undercut threads, for example, a thread lacking a concave side. The type of threads that are desired may depend on the type and/or magnitude of loads to be applied to the fastener. For example, a screw loaded axially away from the bone in which it is implanted may advantageously have a conventional thread, while a screw loaded axially toward the bone in which it is implanted may advantageously have an undercut thread. A screw that may experience multi-axial loading and/or off-loading conditions may advantageously include at least one conventional thread (lacking a concave side) and at least one undercut thread in order to increase bone fixation and load sharing between a bone/fastener interface during multi-axial and off-loading conditions to reduce high bone strain and distribute multi-axial forces applied to the bone in a load-sharing, rather than load-bearing, configuration. Shear loads and/or bending moments may also be optimally resisted with any chosen combination of threading, threading morphology, and/or threading variations contemplated herein to optimally resist shear loads, bending moments, multi-axial loading, off-loading conditions, etc.

In some embodiments, fasteners with conventional threads may be used in conjunction with fasteners with undercut threads in order to accommodate different loading patterns.

In some embodiments, a single fastener may have both conventional and undercut threads, like the fastener 100. Such a combination of threads may help the fastener 100 remain in place with unknown and/or varying loading patterns.

In some embodiments, the geometry of the threading of a fastener (with conventional and/or undercut threads) may be varied to suit the fastener for a particular loading scheme. For example, the number of threads, the number of thread starts (or thread leads), the pitch of the threading, the shape(s) of the threading, any dimension(s) associated with the threading (e.g., any length(s)/width(s)/height(s)/inflection point(s), etc., associated with the threading), the major diameter(s), the minor diameter(s), the pitch diameter(s), any angulation/angles associated with any surfaces of the threading, the “handedness” of the threading (e.g., right-handed vs. left-handed), etc., may be varied accordingly to suit any specific medium of installation, loading pattern, desired radial loading force, pull-out strength, application, procedure, etc., that may be involved.

The material(s) of any portion of a bone implant, joint replacement implant, fastener, bone disunion fastener, etc., described herein may include, but are not limited to: metals (e.g., titanium, cobalt, etc.), metal alloys (stainless steel, titanium alloy, nickel-titanium alloy, etc.), plastics, polymers, ceramics, PEEK, UHMWPE, composites, additive particles, textured surfaces, biologics, biomaterials, bone, etc.

Any of the fasteners or implants described herein may include additional features such as: self-tapping features, cutting flutes, locking features (e.g., locking threading formed on a portion of the fastener, such as threading located on or near a head of the fastener), opening(s), cannulation(s), fenestration(s), any style of fastener head (or no fastener head at all), any style of torque connection interface (or no torque connection interface at all), etc.

The opening(s), cannulation(s), fenestration(s), etc., formed in any of the fasteners or implants described herein may be configured to receive any suitable bone cement or bone augment material therein to facilitate bone in-growth, bone fusion, etc.

In some embodiments, a tap (not shown) may be utilized to pre-form threading in a bone or bone augment material according to any threading shape that is disclosed or contemplated herein. In this manner, taps with any suitable shape may be utilized in conjunction with any fastener described or contemplated herein to match or substantially match the threading geometry of a given fastener or bone implant.

A minor diameter of the fastener may be selected to match, or substantially match, a diameter of a pilot hole that is formed in a bone to avoid bone blowout when the fastener is inserted into the pilot hole.

Additionally, or alternatively thereto, the type of threads and/or thread geometry may be varied based on the type of bone in which the fastener is to be anchored. For example, fasteners anchored in osteoporotic bone may fare better with conventional or undercut threads, or when the pitch, major diameter, and/or minor diameter are increased or decreased, or when the angulation of thread surfaces is adjusted, etc.

The fastener 100 may be one of a set of fasteners each having a different thread option described or contemplated herein. A surgical kit may include multiple fasteners/implants with any of the different fasteners/implants and thread options described or contemplated herein. A surgeon may select the appropriate fasteners/implants from the kit based on the particular loads to be applied and/or the quality of bone in which the fastener/implants are to be anchored.

Continuing with FIG. 1D, the first helical thread 110 may include a plurality of first undercut surfaces 111, a plurality of second undercut surfaces 112, a plurality of third undercut surfaces 113, and a plurality of fourth open surfaces 114.

The second helical thread 120 may include a plurality of fifth undercut surfaces 125, a plurality of sixth undercut surfaces 126, a plurality of seventh undercut surfaces 127, and a plurality of eighth open surfaces 128.

One or more of the plurality of first undercut surfaces 111, the plurality of second undercut surfaces 112, the plurality of third undercut surfaces 113, the plurality of fourth open surfaces 114, the plurality of fifth undercut surfaces 125, the plurality of sixth undercut surfaces 126, the plurality of seventh undercut surfaces 127, and the plurality of eighth open surfaces 128 may include at least one flat or substantially flat surface.

The plurality of first undercut surfaces 111, the plurality of third undercut surfaces 113, the plurality of sixth undercut surfaces 126, and the plurality of eighth open surfaces 128 may be angled towards the distal end 102 of the shaft 105.

The plurality of second undercut surfaces 112, the plurality of fourth open surfaces 114, the plurality of fifth undercut surfaces 125, and the plurality of seventh undercut surfaces 127 may be angled towards the proximal end 101 of the shaft 105.

In some embodiments, when the fastener 100 is viewed in section along a plane that intersects the longitudinal axis 103 of the shaft 105 (as shown in FIG. 1D), the first helical thread 110 may include at least one chevron shape that is oriented toward (i.e., points toward) the distal end 102 of the shaft 105. Likewise, the second helical thread 120 may also include at least one chevron shape that is oriented toward (i.e., points toward) the proximal end 101 of the shaft 105.

When the fastener 100 is viewed in section along a plane that intersects the longitudinal axis 103 of the shaft 105 (as shown in FIG. 1D), the first helical thread 110 may include a first plurality of chevron shapes that are oriented toward (i.e., point toward) the distal end 102 of the shaft 105. Likewise, the second helical thread 120 may include a second plurality of chevron shapes that are oriented toward (i.e., point toward) the proximal end 101 of the shaft 105.

The first plurality of chevron shapes and the second plurality of chevron shapes may be arranged in alternating succession along the shaft 105 of the fastener 100, (e.g., see FIG. 1D).

A plurality of first interlocking spaces 161 and a plurality of second interlocking spaces 162 may be formed between the first helical thread 110 and the second helical thread 120 along the shaft 105 of the fastener 100. The plurality of first interlocking spaces 161 may be formed intermediate the first concave undercut surfaces 131 and the second concave undercut surfaces 132. The plurality of second interlocking spaces 162 may be formed intermediate the first convex undercut surfaces 141 and the second convex undercut surfaces 142. The plurality of first interlocking spaces 161 may be larger in size than the plurality of second interlocking spaces.

The plurality of first interlocking spaces 161 and the plurality of second interlocking spaces 162 may be shaped and/or configured to interlock with bone/other tissues received therein to increase fixation of the fastener 100 within the bone/other tissues and provide additional resistance against multi-axial forces that may be applied to the fastener 100 and/or the bone/other tissues.

The plurality of second undercut surfaces 112 and the plurality of sixth undercut surfaces 126 may be angled toward each other to trap bone/bone augment material within the plurality of first interlocking spaces 161 in order to increase fixation and resistance against multi-axial forces. The plurality of third undercut surfaces 113 and the plurality of seventh undercut surfaces 127 may be angled toward each other to trap bone/other tissues within the plurality of second interlocking spaces 162 in order to increase fixation and resistance against multi-axial forces.

The plurality of first undercut surfaces 111 and the plurality of fifth undercut surfaces 125 may each form an angle α with respect to the longitudinal axis 103 of the shaft 105, as shown in FIG. 1D. The angle α may be greater than 90 degrees.

The plurality of second undercut surfaces 112 and the plurality of sixth undercut surfaces 126 may each form an angle β with respect to the longitudinal axis 103 of the shaft 105. The angle β may be less than 90 degrees.

The plurality of third undercut surfaces 113 and the plurality of seventh undercut surfaces 127 may each form an angle θ with respect to the longitudinal axis 103 of the shaft 105. The angle θ may be approximately 90 degrees. Alternatively, the angle θ may be greater than 90 degrees.

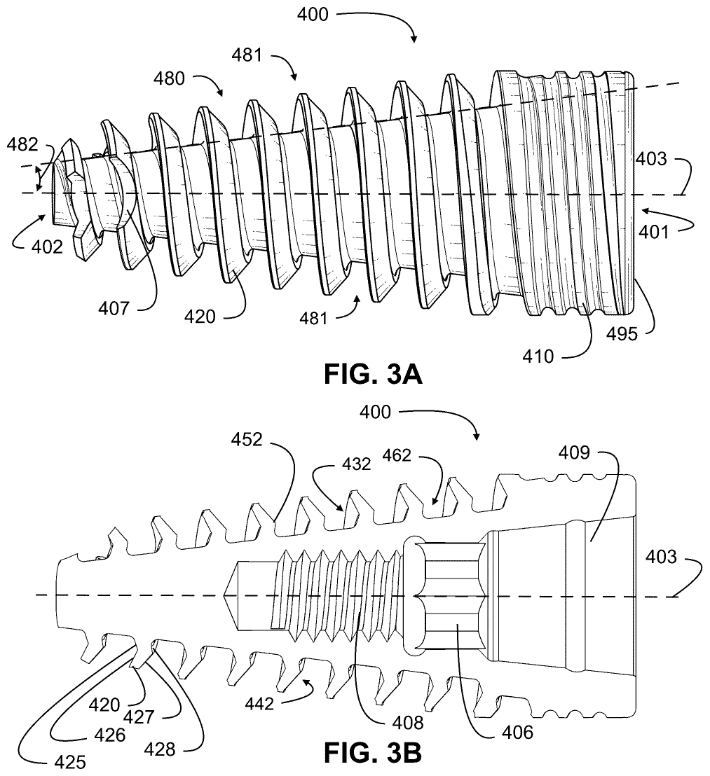

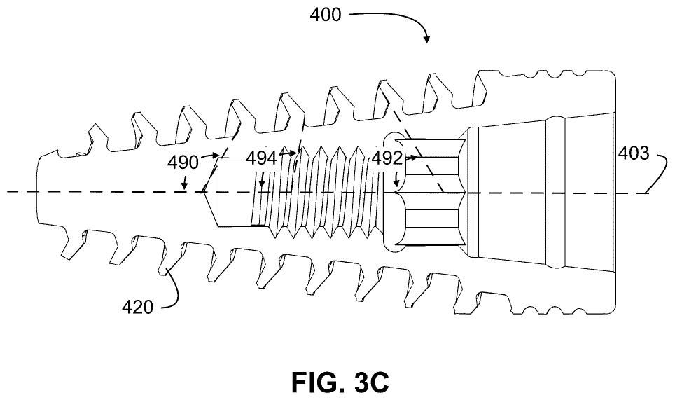

FIG. 3A is a side view of a fastener body 400 according to an embodiment of the present disclosure. FIG. 3B is a cross-sectional side view of the fastener body 400 and FIG. 3C is a cross-sectional side view of the fastener body 400. The fastener body 400 may be configured as a threaded dental implant. The fastener body 400 may be further configured to be secured to a bone and to receive a dental component.

The fastener body 400 may be threadably advanced into the bone after a pilot hole is created. The pilot hole may be sized to be generally equal to a minor thread diameter of the fastener body 400, thereby limiting undue compression and damage to the bone as well as reducing insertion torque.

Some embodiments may have tapered lead-ins with or without threads that transition into either constant minor diameter and/or tapered minor diameter implants. Some embodiments may transition between threads with undercuts and standard buttress or v-style threads. The transitions may be continuous and/or interrupted. Features such as thread forms, sizes, minor diameters, major diameters, transitions, tip shapes, and the like of the various embodiments shown herein may be combined in various ways to generate additional embodiments.

The fastener body 400 may include a helical thread having a tapered major diameter and a tapered minor diameter. The helical thread may include a first thread form including an undercut and/or a concave side that may transition into a micro-thread form. The micro-threads may have a second thread form lacking an undercut and/or a concave side such as a square thread, a V-shaped thread, and/or a buttress thread. The transition may be continuous or distinct. The first thread form may extend to a distal end. The distal end may, or may not, include one or more self-tapping flutes and/or cutting flutes. The minor thread diameter may be tapered such that the minor thread diameter is smaller at the distal end than at the proximal end.

The fastener body 400 may include a body portion 481 having a longitudinal axis 403, a proximal end 401, and a distal end 402. The fastener body 400 may further include a first helical thread disposed about the body portion 481 along the longitudinal axis 403. The first helical thread may include a first thread form 420 and a second thread form 410. A depth of the first helical thread with respect to the body portion 481 may define a major diameter and a minor diameter of the first helical thread. The second thread form 410 may be configured as a conventional thread form and may lack and undercut and/or a generally concave side.

The first thread form may include an undercut or a concave side. The undercut or the concave side may be located on a distal-facing side of the first thread form. The second thread form may have a standard or conventional thread form that lacks an undercut or a generally concave side. The second thread form may have a square thread, a V-shaped thread, and/or a buttress thread. As defined herein, a conventional thread and/or a standard thread may include a thread form lacking an undercut and/or a concave side.

The major diameter and/or the minor diameter of the first helical thread may be tapered along the entire length of the fastener, and/or along a portion of the length of the fastener body 400. The first thread form may include a tapered major diameter and a tapered minor diameter. The second thread form may have a generally constant major diameter and a generally constant minor diameter.

The first helical thread may extend from the proximal end 401 to the distal end 402. Alternatively, the first helical thread may extend from near the proximal end 401 to the near distal end 402. The fastener body 400 may lack a head or any portion that has a diameter greater than a major thread diameter of the first helical portion.

Additionally, or alternatively, the fastener body 400 may include a distal portion 480 proximate the distal end 402. The distal portion 480 may be a tapered portion such that a first diameter at the distal end 402 is less than a second diameter at the proximal end 401. A taper angle 482 may be measured between the longitudinal axis 403 and an axis parallel to the distal portion 480. The taper angle 482 may be between 5 degrees and 25 degrees. More specifically, the taper angle 482 may be between 10 degrees and 20 degrees.

The first helical thread, including the first thread form and the second thread form, may extend along a continuous helical path. The first thread form and the second thread form may have the same pitch. The first thread form and the second thread form may have a constant pitch. Additionally, or alternatively, the first thread form and the second thread form may have a variable pitch while maintaining a smooth transition from the first thread form to the second thread form. Alternatively, the first thread form may extend along a first helical path and the second thread form may extend along a second helical path, that may not be continuous with the first helical path.

The first thread form may extend from the proximal end 401 to the second thread form. The second thread form may extend from the first thread form to the distal end 402. Alternatively, the first thread form may extend from near the proximal end 401 to the second thread form. The second thread form may extend from the first thread form to near the distal end 402.

The first helical thread may include a first thread profile proximate the proximal end 401 and a second thread profile proximate the distal end 402. For example, the first thread profile may include the first thread form 420 while the second thread profile may include a conventional thread form. Alternatively, the first thread profile and the second thread profile may each include any thread form described herein and/or a conventional thread form. Additionally, or alternatively, the first thread profile may gradually morph into the second thread profile along the first helical thread while maintaining a continuous helical path.

Additionally, or alternatively, one of the first thread form and the second thread form may be a single lead thread having a pitch, p. For a single lead thread, one rotation of the fastener advances the fastener by a distance equal to the pitch, p. The other of the first thread form and the second thread form may have a dual-lead thread having a lead length, L. For a dual-lead thread, one rotation of the fastener advances the fastener by a distance equal to the lead length, L. The fastener body 400 may include the first thread form and the second thread form, whereby L=2p so that the fastener body 400 advances the same distance per rotation of the fastener body 400 relative to the bone when either the first thread form or the second thread form is engaged with the bone.

The fastener body 400 may further include a torque connection interface 406 formed in/on the proximal end 401 (in either a male/female configuration), and a cutting flute 407 formed in the distal end 402 of the fastener body 400. The fastener body 400 may include a plurality of cutting flutes 407 radially spaced about the longitudinal axis 403. The proximal end 401 may further include a flat proximal surface 495 that may be perpendicular to the longitudinal axis 403.

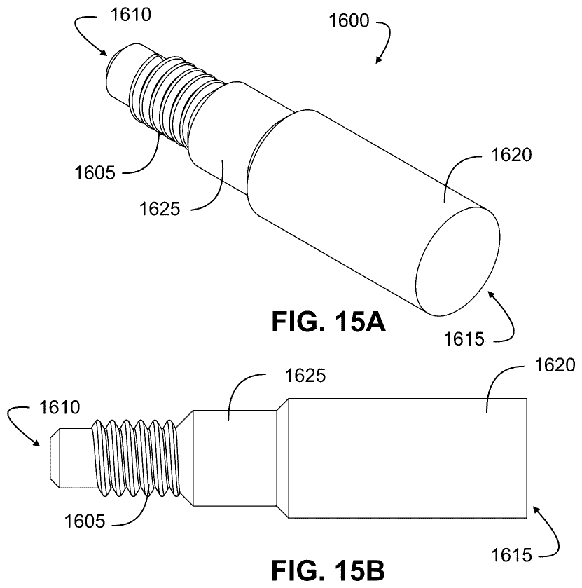

The proximal surface may include a torque connection interface 406, a threaded socket 408, and an internal pocket 409. The torque connection interface 406 may be configured to receive a driver (not shown) configured to transfer torque to the fastener body 400 in order to drive the fastener into the bone. The internal pocket 409 and the threaded socket 408 may be configured to receive a dental component, such as an abutment 1600, an abutment 1700, and/or a dental crown 1800 (as shown in FIG. 15A through FIG. 18B) so that the dental component is secured to the fastener body 400, thereby securing the dental component relative to the bone. The internal pocket 409 may be configured with a taper. The taper may facilitate a taper-lock fit with the abutment 1600 and/or the abutment 1700.

The first thread form 420 may include a plurality of first concave undercut surfaces on a first distal-facing side 432 and a plurality of first convex undercut surfaces on a first proximal-facing side 442.

As shown in FIGS. 3B & 3C, the first distal-facing side 432 may be oriented toward (i.e., point toward) the distal end 402 of the fastener body 400. The first proximal-facing side 442 may be oriented toward (i.e., point toward) the proximal end 401 of the fastener body 400.

At least one of the first distal-facing side 432, and the first proximal-facing side 442 may comprise at least one substantially flat surface.

The first thread form 420 may comprise a plurality of second bent shapes (comprising at least one surface that is angled relative to the longitudinal axis 403 and/or at least one undercut surface) with a plurality of first intermediate portions 452 that are oriented toward (i.e., point toward) the proximal end 401 of the fastener body 400.

In some embodiments, at least one of the first distal-facing side 432, and the first proximal-facing side 442 may include at least one curved surface.

The proximally-oriented and distally-oriented surfaces of the first thread form 420 (i.e., the first proximal-facing side 442 and the first distal-facing side 432) may not have mirror symmetry relative to each other about any plane perpendicular to the longitudinal axis 403. Rather, the first proximal-facing side 442 may be offset from the first distal-facing side 432.

The first thread form 420 may be configured as undercut threads. The first thread form 420 may include a plurality of first undercut surfaces 425, a plurality of second undercut surfaces 426, a plurality of third undercut surfaces 427, and a plurality of fourth open surfaces 428. Undercut threads may differ from conventional threads, as conventional threads lack any undercut surfaces.

The fastener body 400 may have conventional threads and/or undercut threads. The type of threads that are desired may depend on the type and/or magnitude of loads to be applied to the fastener body 400. A screw that may experience multi-axial loading and/or off-loading conditions may advantageously include at least one undercut thread in order to increase bone fixation and load sharing between a bone/fastener interface during multi-axial and off-loading conditions to reduce high bone strain and distribute multi-axial forces applied to the bone in a load-sharing, rather than load-bearing, configuration. Shear loads and/or bending moments may also be optimally resisted with any chosen combination of threading, threading morphology, and/or threading variations contemplated herein to optimally resist shear loads, bending moments, multi-axial loading, off-loading conditions, etc.

The geometry of the threading of the fastener body 400 may be varied to suit the fastener body 400 for a particular loading scheme. For example, the number of threads, the number of thread starts (or thread leads), the pitch of the threading, the shape(s) of the threading, any dimension(s) with associated the threading (e.g., any length(s)/width(s)/height(s)/inflection point(s), etc., associated with the threading), the major diameter(s), the minor diameter(s), the pitch diameter(s), any angulation/angles associated with any surfaces of the threading, the “handedness” of the threading (e.g., right-handed vs. left-handed), etc., may be varied accordingly to suit any specific medium of installation, loading pattern, desired radial loading force, pull-out strength, application, procedure, etc., that may be involved.

A plurality of first interlocking spaces 462 may be formed between the first thread form 420 along the fastener body 400. The plurality of first interlocking spaces 462 may be formed intermediate the first distal-facing side 432 and an adjacent first proximal-facing side 442.

The plurality of first interlocking spaces 462 may be shaped and/or configured to interlock with bone/other tissues received therein to increase fixation of the fastener body 400 within the bone/other tissues and provide additional resistance against multi-axial forces that may be applied to the fastener body 400 and/or the bone/other tissues.

The plurality of second undercut surfaces 426 and the plurality of third undercut surfaces 427 may be angled toward each other to trap bone/bone augment material within the plurality of first interlocking spaces 462 in order to increase fixation and resistance against multi-axial forces.

The plurality of first undercut surfaces 425 may each form an angle 490 with respect to the longitudinal axis 403. The angle 490 may be greater than 90 degrees.

The plurality of second undercut surfaces 426 may each form an angle 492 with respect to the longitudinal axis 403. The angle 492 may be less than 90 degrees.

The plurality of third undercut surfaces 427 may each form an angle 494 with respect to the longitudinal axis 403. The angle 494 may be approximately 90 degrees. Alternatively, the angle 494 may be greater than 90 degrees.

Due to the undercut surfaces, the first thread 420 may not be manufacturable using standard machining methods. The first thread form 420 may be machined using any of the methods described in U.S. Provisional Patent Application Ser. No. 63/569,174 herein incorporated by reference in its entirety.

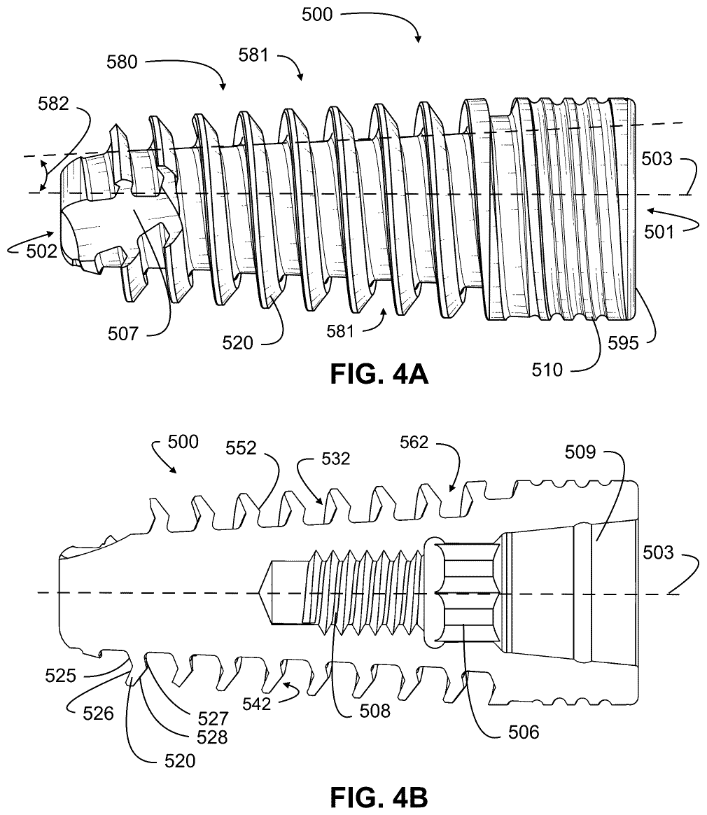

FIG. 4A is a side view of a fastener body 500 according to an embodiment of the present disclosure. FIG. 4B is a cross-sectional side view of the fastener body 500. The fastener body 500 may be configured as a threaded dental implant. The fastener body 500 may be further configured to be secured to a bone and to receive a dental component.

Various parts of the fastener body 500 may be identical or similar to their counterparts on the fastener body 400 presented herein; these parts may not be described again here. All statements made regarding the fastener body 400 may apply to the fastener body 500 unless they would be contradicted by the differences between the two.

The fastener body 500 may include a helical thread having a slightly tapered major diameter and a correspondingly slightly tapered minor diameter. The reduced taper, as compared to the fastener body 400, may result in a relatively longer blunt tip to improve finishing torque and/or depth seating.

The helical thread may include a first thread form including an undercut and/or a concave side that may transition into a micro-thread form. The micro-threads may have a second thread form lacking an undercut and/or a concave side such as a square thread, a V-shaped thread, and/or a buttress thread. The transition may be continuous or distinct. The first thread form may extend to a distal end. The distal end may, or may not, include one or more self-tapping flutes and/or cutting flutes.

The fastener body 500 may include a proximal end 501, a distal end 502, and a body portion 581 having a longitudinal axis 503. The fastener body 500 may further include a first helical thread disposed about the body portion 581 along the longitudinal axis 503. The first helical thread may include a first thread form 520 and a second thread form 510. A depth of the first helical thread with respect to the body portion 581 may define a major diameter and a minor diameter of the first helical thread. The second thread form 510 may be configured as a conventional thread form and may lack and undercut and/or a concave side.

The fastener body 500 may further include a distal portion 580 proximate the distal end 502 and a taper angle 582 measured between the longitudinal axis 503 and an axis parallel to the distal portion 580. The taper angle 582 may be between 2 degrees and 15 degrees. More specifically, the taper angle 582 may be between 5 degrees and 10 degrees.

The fastener body 500 may further include a threaded socket 508, an internal pocket 509, a torque connection interface 506 formed in/on the proximal end 501 (in either a male/female configuration), and a cutting flute 507 formed in the distal end 502 of the fastener body 500. The proximal end 501 may further include a flat proximal surface 595 that may be perpendicular to the longitudinal axis 503.

The first thread form 520 may include a plurality of first concave undercut surfaces on a first distal-facing side 532 and a plurality of first convex undercut surfaces on a first proximal-facing side 542. The first thread form 520 may be configured as undercut threads. The first thread form 520 may include a plurality of first undercut surfaces 525, a plurality of second undercut surfaces 526, a plurality of third undercut surfaces 527, and a plurality of fourth open surfaces 528.

The first thread form 520 may comprise a plurality of second bent shapes (comprising at least one surface that is angled relative to the longitudinal axis 503 and/or at least one undercut surface) with a plurality of first intermediate portions 552 that are oriented toward (i.e., point toward) the proximal end 501 of the fastener body 500. A plurality of first interlocking spaces 562 may be formed between the first thread form 520 along the fastener body 500.

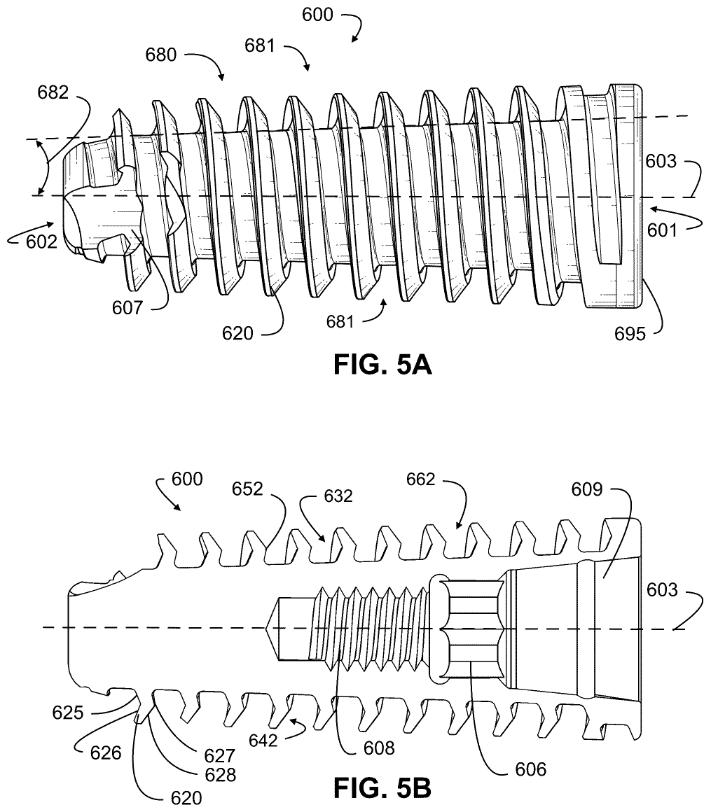

FIG. 5A is a side view of a fastener body 600 according to an embodiment of the present disclosure. FIG. 5B is a cross-sectional side view of the fastener body 600. The fastener body 600 may be configured as a threaded dental implant. The fastener body 600 may be further configured to be secured to a bone and to receive a dental component.

Various parts of the fastener body 600 may be identical or similar to their counterparts on the fastener body 400 presented herein; these parts may not be described again here. All statements made regarding the fastener body 400 may apply to the fastener body 600 unless they would be contradicted by the differences between the two.

The fastener body 500 may include a helical thread having a fully tapered major diameter and a correspondingly fully tapered minor diameter. The fully tapered major diameter and/or minor diameter thread form having an undercut and/or a concave side may present significant manufacturing challenges.

The helical thread may include a first thread form including an undercut and/or a concave side. The distal end may, or may not, include one or more self-tapping flutes and/or cutting flutes.

The fastener body 600 may include a proximal end 601, a distal end 602, and a body portion 681 having a longitudinal axis 603. The fastener body 600 may further include a first helical thread disposed about the body portion 681 along the longitudinal axis 603. The first helical thread may include a first thread form 620. A depth of the first helical thread with respect to the body portion 681 may define a major diameter and a minor diameter of the first helical thread.

The fastener body 600 may further include a distal portion 680 proximate the distal end 602 and a taper angle 682 measured between the longitudinal axis 603 and an axis parallel to the distal portion 680. The taper angle 682 may be between 5 degrees and 25 degrees. More specifically, the taper angle 682 may be between 10 degrees and 20 degrees.

The fastener body 600 may further include a threaded socket 608, an internal pocket 609, a torque connection interface 606 formed in/on the proximal end 601 (in either a male/female configuration), and a cutting flute 607 formed in the distal end 602 of the fastener body 600. The proximal end 601 may further include a flat proximal surface 695 that may be perpendicular to the longitudinal axis 603.

The first thread form 620 may include a plurality of first concave undercut surfaces on a first distal-facing side 632 and a plurality of first convex undercut surfaces on a first proximal-facing side 642. The first thread form 620 may be configured as undercut threads. The first thread form 620 may include a plurality of first undercut surfaces 625, a plurality of second undercut surfaces 626, a plurality of third undercut surfaces 627, and a plurality of fourth open surfaces 628.

The first thread form 620 may comprise a plurality of second bent shapes (comprising at least one surface that is angled relative to the longitudinal axis 603 and/or at least one undercut surface) with a plurality of first intermediate portions 652 that are oriented toward (i.e., point toward) the proximal end 601 of the fastener body 600. A plurality of first interlocking spaces 662 may be formed between the first thread form 620 along the fastener body 600.

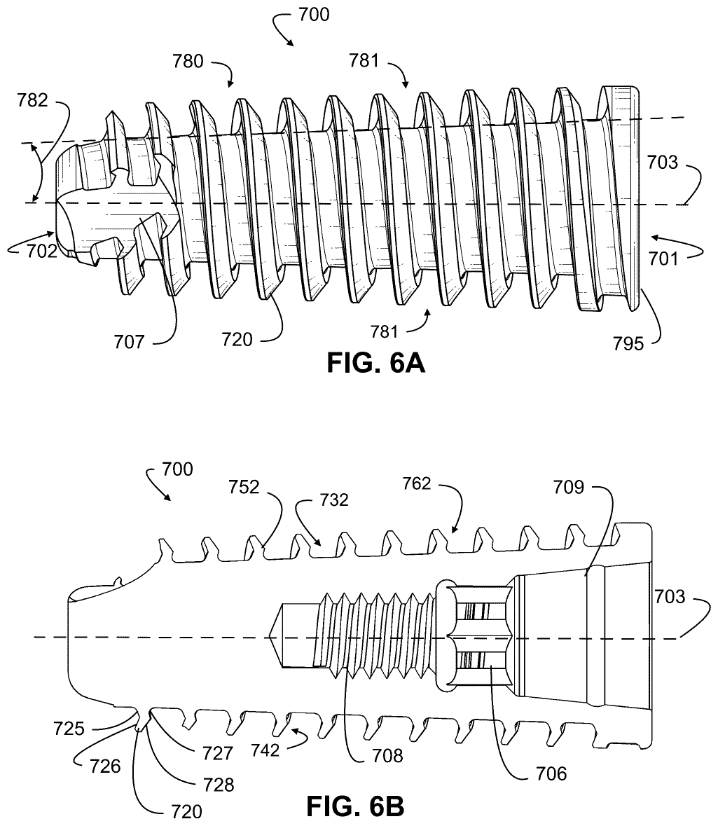

FIG. 6A is a side view of a fastener body 700 according to an embodiment of the present disclosure. FIG. 6B is a cross-sectional side view of the fastener body 700. The fastener body 700 may be configured as a threaded dental implant. The fastener body 700 may be further configured to be secured to a bone and to receive a dental component.

Various parts of the fastener body 700 may be identical or similar to their counterparts on the fastener body 400 presented herein; these parts may not be described again here. All statements made regarding the fastener body 400 may apply to the fastener body 700 unless they would be contradicted by the differences between the two.

The fastener body 700 may include a helical thread having a slightly tapered major diameter and a correspondingly slightly tapered minor diameter. The reduced taper, as compared to the fastener body 400, may result in a relatively longer blunt tip to improve finishing torque and/or depth seating.

The helical thread may include a first thread form including an undercut and/or a concave side. The first thread form may extend to a distal end. The distal end may, or may not, include one or more self-tapping flutes and/or cutting flutes.

The fastener body 700 may include a proximal end 701, a distal end 702, and a body portion 781 having a longitudinal axis 703. The fastener body 700 may further include a first helical thread disposed about the body portion 781 along the longitudinal axis 703. The first helical thread may include a first thread form 720. A depth of the first helical thread with respect to the body portion 781 may define a major diameter and a minor diameter of the first helical thread.

The fastener body 700 may further include a distal portion 780 proximate the distal end 702 and a taper angle 782 measured between the longitudinal axis 703 and an axis parallel to the distal portion 780. The taper angle 782 may be between 2 degrees and 15 degrees. More specifically, the taper angle 782 may be between 5 degrees and 10 degrees.

The fastener body 700 may further include a threaded socket 708, an internal pocket 709, a torque connection interface 706 formed in/on the proximal end 701 (in either a male/female configuration), and a cutting flute 707 formed in the distal end 702 of the fastener body 700. The proximal end 701 may further include a flat proximal surface 795 that may be perpendicular to the longitudinal axis 703.

The first thread form 720 may include a plurality of first concave undercut surfaces on a first distal-facing side 732 and a plurality of first convex undercut surfaces on a first proximal-facing side 742. The first thread form 720 may be configured as undercut threads. The first thread form 720 may include a plurality of first undercut surfaces 725, a plurality of second undercut surfaces 726, a plurality of third undercut surfaces 727, and a plurality of fourth open surfaces 728.

The first thread form 720 may comprise a plurality of second bent shapes (comprising at least one surface that is angled relative to the longitudinal axis 703 and/or at least one undercut surface) with a plurality of first intermediate portions 752 that are oriented toward (i.e., point toward) the proximal end 701 of the fastener body 700. A plurality of first interlocking spaces 762 may be formed between the first thread form 720 along the fastener body 700.

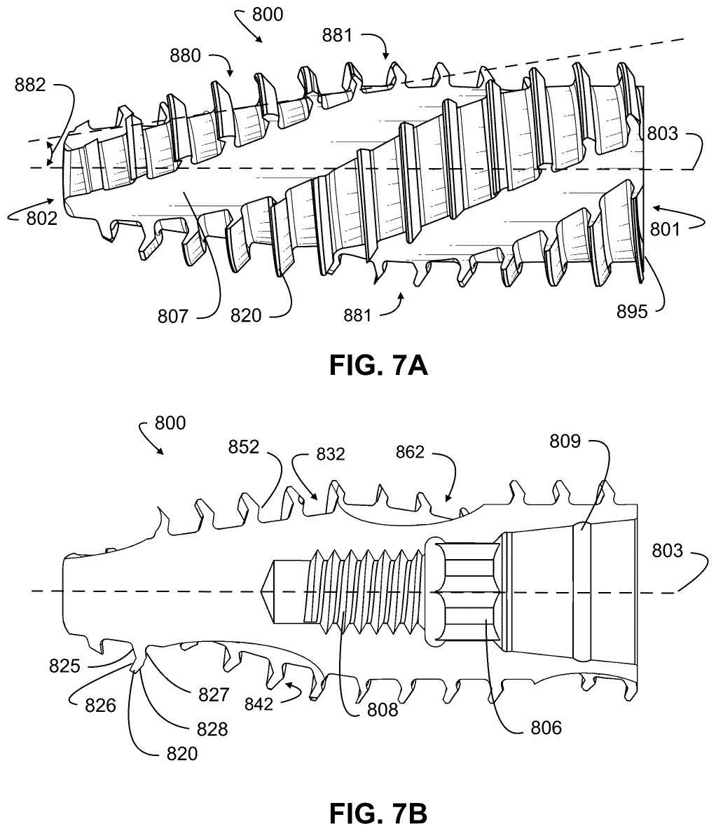

FIG. 7A is a side view of a fastener body 800 according to an embodiment of the present disclosure. FIG. 7B is a cross-sectional side view of the fastener body 800. The fastener body 800 may be configured as a threaded dental implant. The fastener body 800 may be further configured to be secured to a bone and to receive a dental component.

Various parts of the fastener body 800 may be identical or similar to their counterparts on the fastener body 400 presented herein; these parts may not be described again here. All statements made regarding the fastener body 400 may apply to the fastener body 800 unless they would be contradicted by the differences between the two.

The fastener body 800 may include a helical thread including a first portion having a tapered major diameter and a correspondingly slightly tapered minor diameter and a second portion having a generally constant major diameter and a correspondingly generally constant minor diameter.

The helical thread may include a first thread form including an undercut and/or a concave side. The first thread form may extend to a distal end. The distal end may, or may not, include one or more self-tapping flutes and/or cutting flutes. The tapered major diameter and/or the tapered minor diameter at the distal end may help initiate and/or navigate anatomical constraints. The threaded major/minor diameters may transition smoothly to the constant major/minor diameters to reduce outward forces.

The fastener body 800 may include a proximal end 801, a distal end 802, and a body portion 881 having a longitudinal axis 803. The fastener body 800 may further include a first helical thread disposed about the body portion 881 along the longitudinal axis 803. The first helical thread may include a first thread form 820. A depth of the first helical thread with respect to the body portion 881 may define a major diameter and a minor diameter of the first helical thread.

The fastener body 800 may further include a distal portion 880 proximate the distal end 802 and a taper angle 882 measured between the longitudinal axis 803 and an axis parallel to the distal portion 880. The taper angle 882 may between 5 degrees and 25 degrees. More specifically, the taper angle 882 may be between 10 degrees and 20 degrees.

The fastener body 800 may further include a threaded socket 808, an internal pocket 809, a torque connection interface 806 formed in/on the proximal end 801 (in either a male/female configuration), and a cutting flute 807 extending from the distal end 802 to the proximal end 801. The cutting flute 807 may follow a helical path from the distal end 802 to the proximal end 801. Alternatively, the cutting flute 807 may follow a straight path from the distal end 802 to the proximal end 801. The fastener body 800 may include a plurality of cutting flutes 807 radially spaced about the longitudinal axis 803. The proximal end 801 may further include a flat proximal surface 895 that may be perpendicular to the longitudinal axis 803.

The first thread form 820 may include a plurality of first concave undercut surfaces on a first distal-facing side 832 and a plurality of first convex undercut surfaces on a first proximal-facing side 842. The first thread form 820 may be configured as undercut threads. The first thread form 820 may include a plurality of first undercut surfaces 825, a plurality of second undercut surfaces 826, a plurality of third undercut surfaces 827, and a plurality of fourth open surfaces 828.

The first thread form 820 may comprise a plurality of second bent shapes (comprising at least one surface that is angled relative to the longitudinal axis 803 and/or at least one undercut surface) with a plurality of first intermediate portions 852 that are oriented toward (i.e., point toward) the proximal end 801 of the fastener body 800. A plurality of first interlocking spaces 862 may be formed between the first thread form 820 along the fastener body 800.

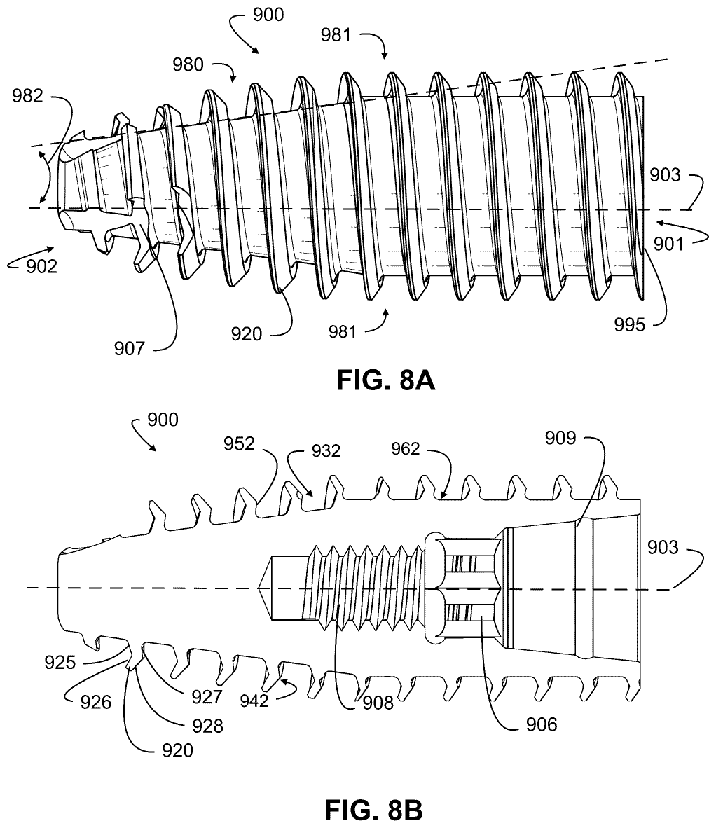

FIG. 8A is a side view of a fastener body 900 according to an embodiment of the present disclosure. FIG. 8B is a cross-sectional side view of the fastener body 900. The fastener body 900 may be configured as a threaded dental implant. The fastener body 900 may be further configured to be secured to a bone and to receive a dental component.

Various parts of the fastener body 900 may be identical or similar to their counterparts on the fastener body 400 presented herein; these parts may not be described again here. All statements made regarding the fastener body 400 may apply to the fastener body 900 unless they would be contradicted by the differences between the two.

The fastener body 900 may include a helical thread including a first portion having a tapered major diameter and a correspondingly tapered minor diameter and a second portion having a generally constant major diameter and a correspondingly generally constant minor diameter.

The helical thread may include a first thread form including an undercut and/or a concave side. The first thread form may extend to a distal end. The distal end may, or may not, include one or more self-tapping flutes and/or cutting flutes. The tapered major diameter and/or the tapered minor diameter at the distal end may help initiate and/or navigate anatomical constraints. The threaded major/minor diameters may transition smoothly to the constant major/minor diameters to reduce outward forces.

The fastener body 900 may include a proximal end 901, a distal end 902, and a body portion 981 having a longitudinal axis 903. The fastener body 900 may further include a first helical thread disposed about the body portion 981 along the longitudinal axis 903. The first helical thread may include a first thread form 920. A depth of the first helical thread with respect to the body portion 981 may define a major diameter and a minor diameter of the first helical thread.

The fastener body 900 may further include a distal portion 980 proximate the distal end 902 and a taper angle 982 measured between the longitudinal axis 903 and an axis parallel to the distal portion 980. The taper angle 982 may between 5 degrees and 25 degrees. More specifically, the taper angle 982 may be between 10 degrees and 20 degrees.

The fastener body 900 may further include a threaded socket 908, an internal pocket 909, a torque connection interface 906 formed in/on the proximal end 901 (in either a male/female configuration), and a cutting flute 907. The fastener body 900 may include a plurality of cutting flutes 907 radially spaced about the longitudinal axis 903. The proximal end 901 may further include a flat proximal surface 995 that may be perpendicular to the longitudinal axis 903.

The first thread form 920 may include a plurality of first concave undercut surfaces on a first distal-facing side 932 and a plurality of first convex undercut surfaces on a first proximal-facing side 942. The first thread form 920 may be configured as undercut threads. The first thread form 920 may include a plurality of first undercut surfaces 925, a plurality of second undercut surfaces 926, a plurality of third undercut surfaces 927, and a plurality of fourth open surfaces 928.

The first thread form 920 may comprise a plurality of second bent shapes (comprising at least one surface that is angled relative to the longitudinal axis 903 and/or at least one undercut surface) with a plurality of first intermediate portions 952 that are oriented toward (i.e., point toward) the proximal end 901 of the fastener body 900. A plurality of first interlocking spaces 962 may be formed between the first thread form 920 along the fastener body 900.

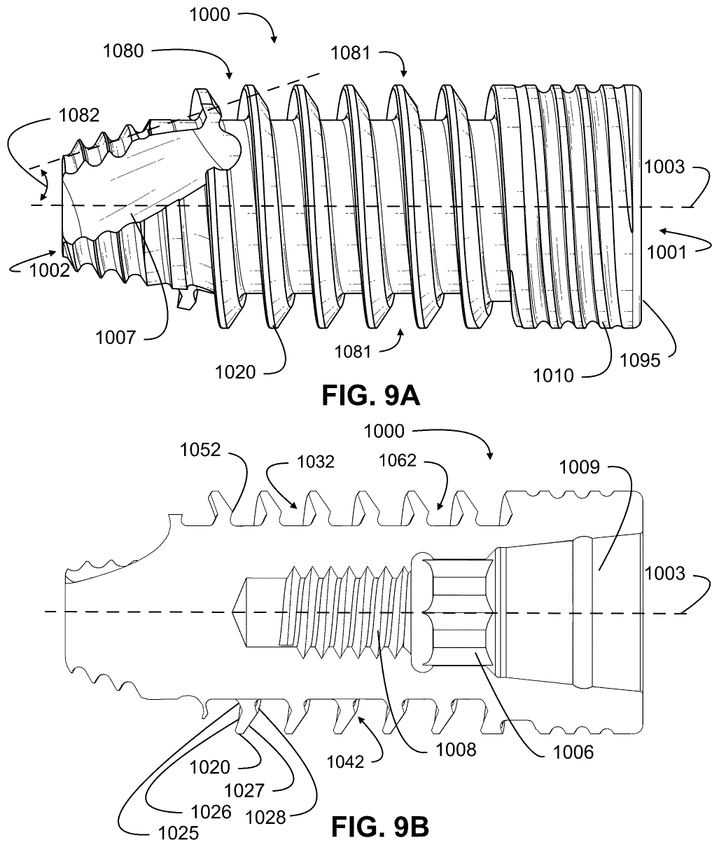

FIG. 9A is a side view of a fastener body 1000 according to an embodiment of the present disclosure. FIG. 9B is a cross-sectional side view of the fastener body 1000. The fastener body 1000 may be configured as a threaded dental implant. The fastener body 1000 may be further configured to be secured to a bone and to receive a dental component.

Various parts of the fastener body 1000 may be identical or similar to their counterparts on the fastener body 400 presented herein; these parts may not be described again here. All statements made regarding the fastener body 400 may apply to the fastener body 1000 unless they would be contradicted by the differences between the two.

The fastener body 1000 may include a helical thread including a first portion having a tapered major diameter and a correspondingly tapered minor diameter and a second portion having a generally constant major diameter and a correspondingly generally constant minor diameter. The fastener body may include a tapered lead-in portion proximate the distal end. The tapered lead-in portion may lack a helical thread.

The helical thread may include a first thread form including an undercut and/or a concave side that may transition into a micro-thread form. The micro-threads may have a second thread form lacking an undercut and/or a concave side such as a square thread, a V-shaped thread, and/or a buttress thread. The transition may be continuous or distinct. The first thread form may extend to a distal end. The distal end may, or may not, include one or more self-tapping flutes and/or cutting flutes.

The fastener body 1000 may include a proximal end 1001, a distal end 1002, and a body portion 1081 having a longitudinal axis 1003. The fastener body 1000 may further include a first helical thread disposed about the body portion 1081 along the longitudinal axis 1003. The first helical thread may include a first thread form 1020 and a second thread form 1010. A depth of the first helical thread with respect to the body portion 1081 may define a major diameter and a minor diameter of the first helical thread. The second thread form 1010 may be configured as a conventional thread form and may lack and undercut and/or a concave side.

The fastener body 1000 may further include a distal portion 1080 proximate the distal end 1002 and a taper angle 1082 measured between the longitudinal axis 1003 and an axis parallel to the distal portion 1080. The taper angle 1082 may be between 5 degrees and 35 degrees. More specifically, the taper angle 1082 may be between 15 degrees and 25 degrees.

The fastener body 1000 may further include a threaded socket 1008, an internal pocket 1009, a torque connection interface 1006 formed in/on the proximal end 1001 (in either a male/female configuration), and a cutting flute 1007 formed in the distal end 1002 of the fastener body 1000. The proximal end 1001 may further include a flat proximal surface 1095 that may be perpendicular to the longitudinal axis 1003.

The first thread form 1020 may include a plurality of first concave undercut surfaces on a first distal-facing side 1032 and a plurality of first convex undercut surfaces on a first proximal-facing side 1042. The first thread form 1020 may be configured as undercut threads. The first thread form 1020 may include a plurality of first undercut surfaces 1025, a plurality of second undercut surfaces 1026, a plurality of third undercut surfaces 1027, and a plurality of fourth open surfaces 1028.

The first thread form 1020 may comprise a plurality of second bent shapes (comprising at least one surface that is angled relative to the longitudinal axis 1003 and/or at least one undercut surface) with a plurality of first intermediate portions 1052 that are oriented toward (i.e., point toward) the proximal end 1001 of the fastener body 1000. A plurality of first interlocking spaces 1062 may be formed between the first thread form 1020 along the fastener body 1000.

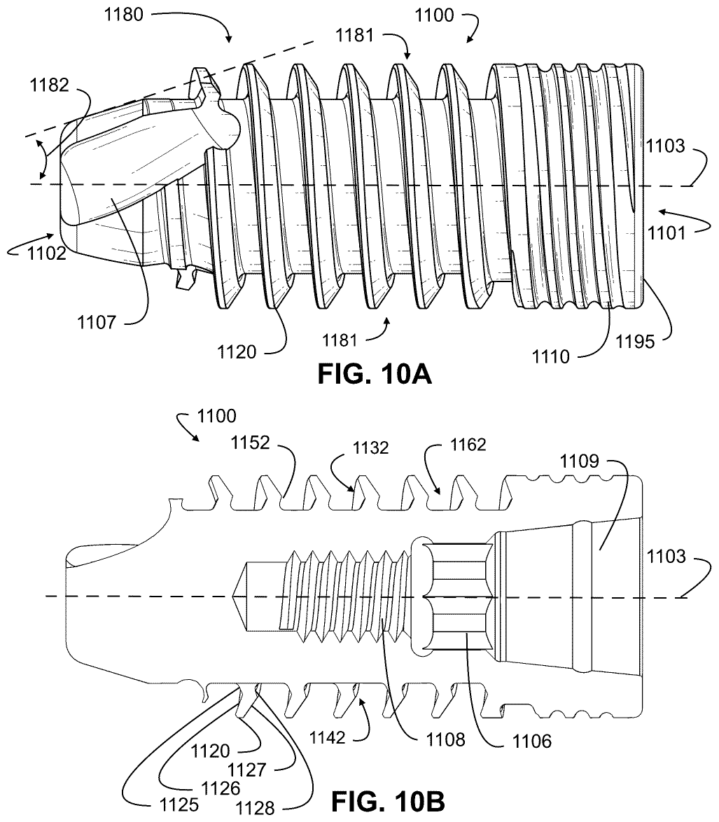

FIG. 10A is a side view of a fastener body 1100 according to an embodiment of the present disclosure. FIG. 10B is a cross-sectional side view of the fastener body 1100. The fastener body 1100 may be configured as a threaded dental implant. The fastener body 1100 may be further configured to be secured to a bone and to receive a dental component.

Various parts of the fastener body 1100 may be identical or similar to their counterparts on the fastener body 400 presented herein; these parts may not be described again here. All statements made regarding the fastener body 400 may apply to the fastener body 1100 unless they would be contradicted by the differences between the two.

The fastener body 1100 may include a helical thread including a first portion having a tapered major diameter and a correspondingly tapered minor diameter and a second portion having a generally constant major diameter and a correspondingly generally constant minor diameter.

The helical thread may include a first thread form including an undercut and/or a concave side that may transition into a micro-thread form. The micro-threads may have a second thread form lacking an undercut and/or a concave side such as a square thread, a V-shaped thread, and/or a buttress thread. The transition may be continuous or distinct. The first thread form may extend to a distal end. The distal end may, or may not, include one or more self-tapping flutes and/or cutting flutes.

The fastener body 1100 may include a proximal end 1101, a distal end 1102, and a body portion 1181 having a longitudinal axis 1103. The fastener body 1100 may further include a first helical thread disposed about the body portion 1181 along the longitudinal axis 1103. The first helical thread may include a first thread form 1120 and a second thread form 1110. A depth of the first helical thread with respect to the body portion 1181 may define a major diameter and a minor diameter of the first helical thread. The second thread form 1110 may be configured as a conventional thread form and may lack and undercut and/or a concave side.

The fastener body 1100 may further include a distal portion 1180 proximate the distal end 1102 and a taper angle 1182 measured between the longitudinal axis 1103 and an axis parallel to the distal portion 1180. The taper angle 1182 may be between 5 degrees and 35 degrees. More specifically, the taper angle 1182 may be between 15 degrees and 25 degrees. A tapered portion of the distal end 1102 may be absent any threads.

The fastener body 1100 may further include a threaded socket 1108, an internal pocket 1109, a torque connection interface 1106 formed in/on the proximal end 1101 (in either a male/female configuration), and a cutting flute 1107 formed in the distal end 1102 of the fastener body 1100. The proximal end 1101 may further include a flat proximal surface 1195 that may be perpendicular to the longitudinal axis 1103.

The first thread form 1120 may include a plurality of first concave undercut surfaces on a first distal-facing side 1132 and a plurality of first convex undercut surfaces on a first proximal-facing side 1142. The first thread form 1120 may be configured as undercut threads. The first thread form 1120 may include a plurality of first undercut surfaces 1125, a plurality of second undercut surfaces 1126, a plurality of third undercut surfaces 1127, and a plurality of fourth open surfaces 1128.

The first thread form 1120 may comprise a plurality of second bent shapes (comprising at least one surface that is angled relative to the longitudinal axis 1103 and/or at least one undercut surface) with a plurality of first intermediate portions 1152 that are oriented toward (i.e., point toward) the proximal end 1101 of the fastener body 1100. A plurality of first interlocking spaces 1162 may be formed between the first thread form 1120 along the fastener body 1100.

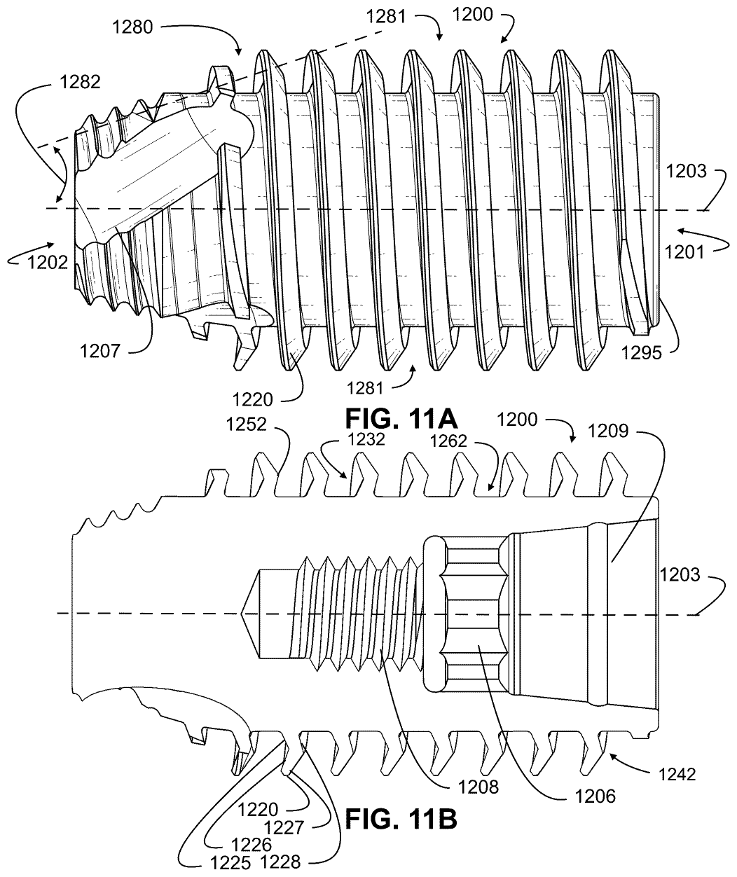

FIG. 11A is a side view of a fastener body 1200 according to an embodiment of the present disclosure. FIG. 11B is a cross-sectional side view of the fastener body 1200. The fastener body 1200 may be configured as a threaded dental implant. The fastener body 1200 may be further configured to be secured to a bone and to receive a dental component.

Various parts of the fastener body 1200 may be identical or similar to their counterparts on the fastener body 400 presented herein; these parts may not be described again here. All statements made regarding the fastener body 400 may apply to the fastener body 1200 unless they would be contradicted by the differences between the two.

The fastener body 1200 may include a helical thread including a first portion having a tapered major diameter and a correspondingly tapered minor diameter and a second portion having a generally constant major diameter and a correspondingly generally constant minor diameter.

The helical thread may include a first thread form including an undercut and/or a concave side. The first thread form may extend to a distal end. The distal end may, or may not, include one or more self-tapping flutes and/or cutting flutes.

The fastener body 1200 may include a proximal end 1201, a distal end 1202, and a body portion 1281 having a longitudinal axis 1203. The fastener body 1200 may further include a first helical thread disposed about the body portion 1281 along the longitudinal axis 1203. The first helical thread may include a first thread form 1220. A depth of the first helical thread with respect to the body portion 1281 may define a major diameter and a minor diameter of the first helical thread.

The fastener body 1200 may further include a distal portion 1280 proximate the distal end 1202 and a taper angle 1282 measured between the longitudinal axis 1203 and an axis parallel to the distal portion 1280. The taper angle 1282 may be between 5 degrees and 35 degrees. More specifically, the taper angle 1282 may be between 15 degrees and 25 degrees.

The fastener body 1200 may further include a threaded socket 1208, an internal pocket 1209, a torque connection interface 1206 formed in/on the proximal end 1201 (in either a male/female configuration), and a cutting flute 1207 formed in the distal end 1202 of the fastener body 1200. The proximal end 1201 may further include a flat proximal surface 1295 that may be perpendicular to the longitudinal axis 1203.

The first thread form 1220 may include a plurality of first concave undercut surfaces on a first distal-facing side 1232 and a plurality of first convex undercut surfaces on a first proximal-facing side 1242. The first thread form 1220 may be configured as undercut threads. The first thread form 1220 may include a plurality of first undercut surfaces 1225, a plurality of second undercut surfaces 1226, a plurality of third undercut surfaces 1227, and a plurality of fourth open surfaces 1228.

The first thread form 1220 may comprise a plurality of second bent shapes (comprising at least one surface that is angled relative to the longitudinal axis 1203 and/or at least one undercut surface) with a plurality of first intermediate portions 1252 that are oriented toward (i.e., point toward) the proximal end 1201 of the fastener body 1200. A plurality of first interlocking spaces 1262 may be formed between the first thread form 1220 along the fastener body 1200.

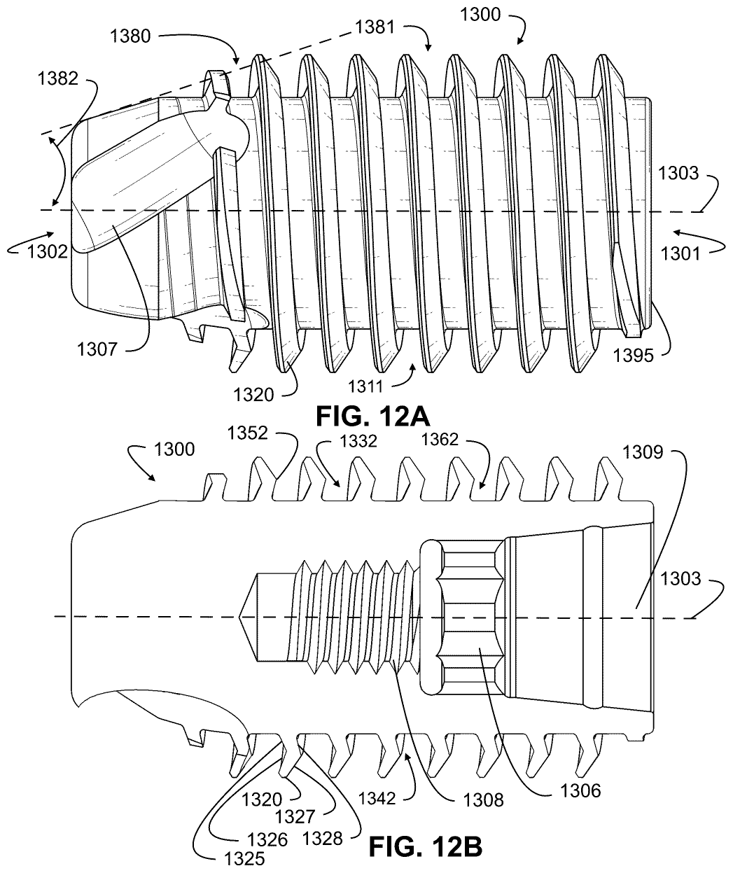

FIG. 12A is a side view of a fastener body 1300 according to an embodiment of the present disclosure. FIG. 12B is a cross-sectional side view of the fastener body 1300. The fastener body 1300 may be configured as a threaded dental implant. The fastener body 1300 may be further configured to be secured to a bone and to receive a dental component.

Various parts of the fastener body 1300 may be identical or similar to their counterparts on the fastener body 400 presented herein; these parts may not be described again here. All statements made regarding the fastener body 400 may apply to the fastener body 1300 unless they would be contradicted by the differences between the two.

The fastener body 1300 may include a helical thread including a first portion having a tapered major diameter and a correspondingly tapered minor diameter and a second portion having a generally constant major diameter and a correspondingly generally constant minor diameter.

The helical thread may include a first thread form including an undercut and/or a concave side. The first thread form may not extend to a distal end. The distal end may, or may not, include one or more self-tapping flutes and/or cutting flutes.

The fastener body 1300 may include a proximal end 1301, a distal end 1302, and a body portion 1381 having a longitudinal axis 1303. The fastener body 1300 may further include a first helical thread disposed about the body portion 1381 along the longitudinal axis 1303. The first helical thread may include a first thread form 1320. A depth of the first helical thread with respect to the body portion 1381 may define a major diameter and a minor diameter of the first helical thread.

The fastener body 1300 may further include a distal portion 1380 proximate the distal end 1302 and a taper angle 1382 measured between the longitudinal axis 1303 and an axis parallel to the distal portion 1380. The taper angle 1382 may be between 5 degrees and 35 degrees. More specifically, the taper angle 1382 may be between 15 degrees and 25 degrees. A tapered portion of the distal end 1302 may be absent any threads.

The fastener body 1300 may further include a threaded socket 1308, an internal pocket 1309, a torque connection interface 1306 formed in/on the proximal end 1301 (in either a male/female configuration), and a cutting flute 1307 formed in the distal end 1302 of the fastener body 1300. The proximal end 1301 may further include a flat proximal surface 1395 that may be perpendicular to the longitudinal axis 1303.

The first thread form 1320 may include a plurality of first concave undercut surfaces on a first distal-facing side 1332 and a plurality of first convex undercut surfaces on a first proximal-facing side 1342. The first thread form 1320 may be configured as undercut threads. The first thread form 1320 may include a plurality of first undercut surfaces 1325, a plurality of second undercut surfaces 1326, a plurality of third undercut surfaces 1327, and a plurality of fourth open surfaces 1328.

The first thread form 1320 may comprise a plurality of second bent shapes (comprising at least one surface that is angled relative to the longitudinal axis 1303 and/or at least one undercut surface) with a plurality of first intermediate portions 1352 that are oriented toward (i.e., point toward) the proximal end 1301 of the fastener body 1300. A plurality of first interlocking spaces 1362 may be formed between the first thread form 1320 along the fastener body 1300.

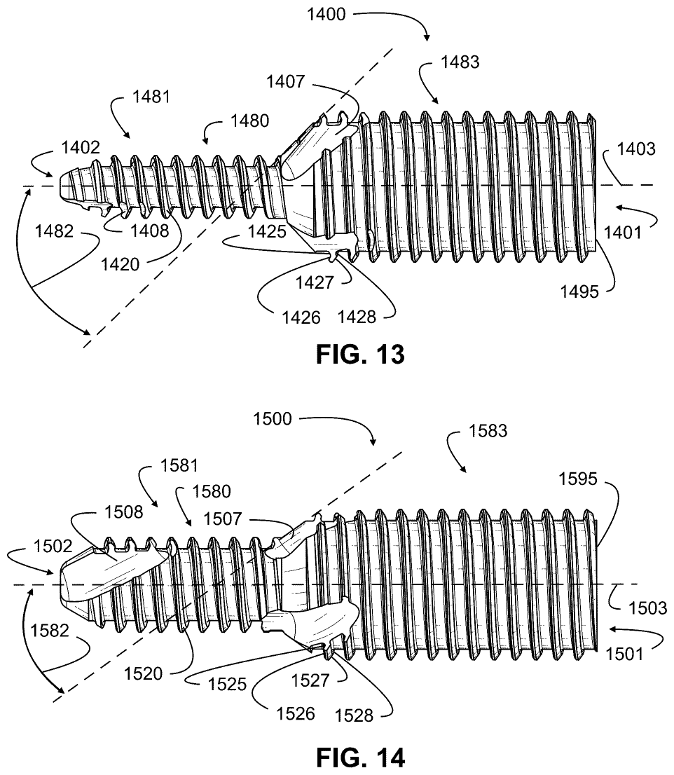

FIG. 13 is a side view of a fastener body 1400 according to an embodiment of the present disclosure. The fastener body 1400 may be configured as a threaded dental implant. The fastener body 1400 may be further configured to be secured to a bone and to receive a dental component.

Various parts of the fastener body 1400 may be identical or similar to their counterparts on the fastener body 400 presented herein; these parts may not be described again here. All statements made regarding the fastener body 400 may apply to the fastener body 1400 unless they would be contradicted by the differences between the two.

The fastener body 1400 may include a first helical thread having a generally constant first major diameter and a correspondingly generally constant first minor diameter. The fastener body 1400 may further include a second helical thread having a generally constant second major diameter and a correspondingly generally constant second minor diameter. The second major diameter may be greater than the first major diameter. The second minor diameter may be greater than the first minor diameter.

The first helical thread may include a first thread form including an undercut and/or a concave side. The first thread form may extend from a distal end. The distal end may, or may not, include one or more first self-tapping flutes and/or cutting flutes.

The second helical thread may include a second thread form including an undercut and/or a concave side. The second thread form may extend from a proximal end. A transition taper between the first major diameter and the second major diameter may, or may not, include a second cutting flute 1408.

The fastener body 1400 may include a proximal end 1401, a distal end 1402, and a first body portion 1481 having a longitudinal axis 1403 and a second body portion 1483 about the longitudinal axis 1403. The fastener body 1400 may further include a first helical thread disposed about the first body portion 1481 along the longitudinal axis 1403. The first helical thread may include a first thread form 1420. A depth of the first helical thread with respect to the first body portion 1481 may define a major diameter and a minor diameter of the first helical thread.

The fastener body 1400 may further include a second helical thread disposed about the second body portion 1483 along the longitudinal axis 1403. The second helical thread may include a first thread form 1420. A depth of the second helical thread with respect to the second body portion 1483 may define a major diameter and a minor diameter of the second helical thread.

The fastener body 1400 may further include a distal portion 1480 proximate the distal end 1402 and a taper angle 1482 measured between the longitudinal axis 1403 and an axis parallel to the distal portion 1480. The taper angle 1482 may be between 30 degrees and 60 degrees. More specifically, the taper angle 1482 may be between 40 degrees and 50 degrees.

The fastener body 1400 may further include a first cutting flute 1407 formed in the distal end 1402 of the fastener body 1400. The proximal end 1401 may further include a flat proximal surface 1495 that may be perpendicular to the longitudinal axis 1403.

The first thread form 1420 may be configured as undercut threads. The first thread form 1420 may include a plurality of first undercut surfaces 1425, a plurality of second undercut surfaces 1426, a plurality of third undercut surfaces 1427, and a plurality of fourth open surfaces 1428.

FIG. 14 is a side view of a fastener body 1500 according to an embodiment of the present disclosure. The fastener body 1500 may be configured as a threaded dental implant. The fastener body 1500 may be further configured to be secured to a bone and to receive a dental component.

Various parts of the fastener body 1500 may be identical or similar to their counterparts on the fastener body 1400 presented herein; these parts may not be described again here. All statements made regarding the fastener body 1400 may apply to the fastener body 1500 unless they would be contradicted by the differences between the two. The fastener body 1500 may include a first body portion 1581 and a second body portion 1583 such that, relative to the fastener body 1400, the first body portion 1581 include a larger diameter than the first body portion 1481. The second body portion 1583 may include a generally equal diameter to the second body portion 1483.

The fastener body 1500 may further include a proximal end 1501, a distal end 1502, a longitudinal axis 1503, a first thread form 1520, a distal portion 1580, a taper angle 1582, a first cutting flute 1507, a second cutting flute 1508, and a flat proximal surface 1595. The first thread form 1520 may include a plurality of first undercut surfaces 1525, a plurality of second undercut surfaces 1526, a plurality of third undercut surfaces 1527, and a plurality of fourth open surfaces 1528.

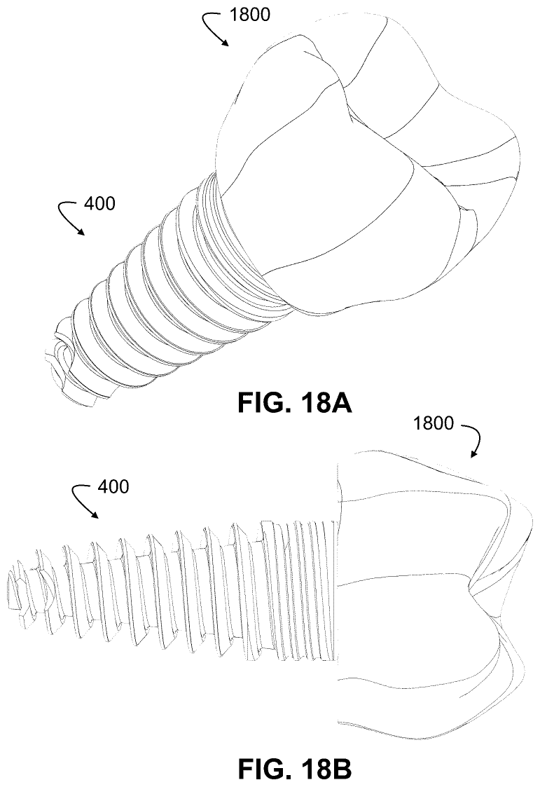

FIG. 15A is a perspective view of an abutment 1600 according to an embodiment of the present disclosure. FIG. 15B is a side view of the abutment 1600. The abutment 1600 may be configured to be received in a fastener body 400 and provide a post and/or anchor point for a dental crown 1800 (as shown in FIGS. 18A & 18B), a dental bridge, and/or another prosthetic dental component. The abutment 1600 may be threadably connectable to the fastener body 400 so that the abutment 1600 may be received in the fastener body 400 after the fastener body 400 is implanted with a bone. Additionally, or alternatively, the abutment 1600 may be connected to the fastener body 400 prior to implantation on the fastener body 400 into the bone.

The abutment 1600 may include a distal portion 1610, a proximal portion 1615, and a central portion 1625 located between the distal portion 1610 and the proximal portion 1615. The distal portion 1610 may include a threaded portion 1605. The threaded portion 1605 may be configured to be threadably engage threaded socket 408 to secure the abutment 1600 to the fastener body 400.

The proximal portion 1615 may include a post portion 1620. The post portion 1620 may extend beyond the proximal end 401 of the fastener body 400, with the abutment 1600 secured to the fastener body 400. The post portion 1620 may provide a post and/or an anchor point for a dental crown 1800 (as shown in FIGS. 18A & 18B), a dental bridge, and/or another prosthetic dental component.

The proximal portion 1615 may be sized to be received in the internal pocket 409 of the fastener body 400 and may provide additional contact area between the abutment 1600 and the fastener body 400 to provide secure engagement between the two. The central portion 1625 may be sized to be rotatably received in the torque connection interface 406.

The post portion 1620 may be configured with a single flat, a double flat, a square, a hex, or another non-circular profile to facilitate transmission of a torque from a driver tool to the abutment 1600. Alternatively, the post portion 1620 may include a circular profile.

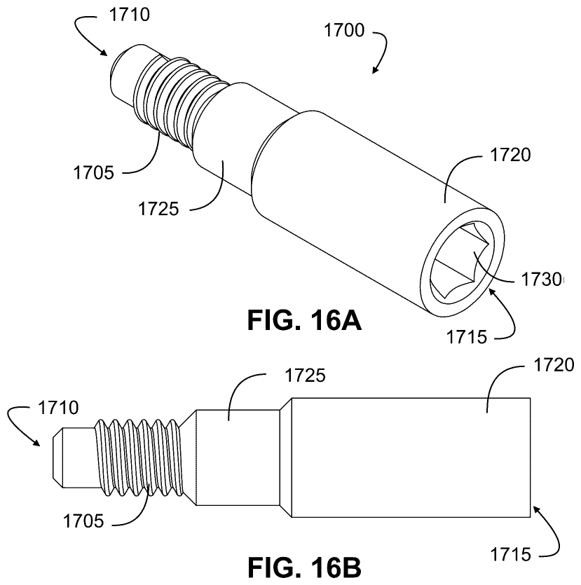

FIG. 16A is a perspective view of an abutment 1700 according to an embodiment of the present disclosure. FIG. 16B is a side view of the abutment 1700. Various parts of the abutment 1700 may be identical or similar to their counterparts on the abutment 1600 presented herein; these parts may not be described again here. All statements made regarding the abutment 1600 may apply to the abutment 1700 unless they would be contradicted by the differences between the two. The abutment 1700 may include a threaded portion 1705, a distal portion 1710, a proximal portion 1715, a post portion 1720, and a central portion 1725.

The proximal portion 1715 may include a torque connection interface 1730. The torque connection interface 1730 may be configured to receive a driver (not shown) configured to transfer torque to the abutment 1700 in order to drive the abutment 1700 into the fastener body 400. The torque connection interface 1730 may be configured as a hex, a square, a hexalobe, or another non-circular profile.

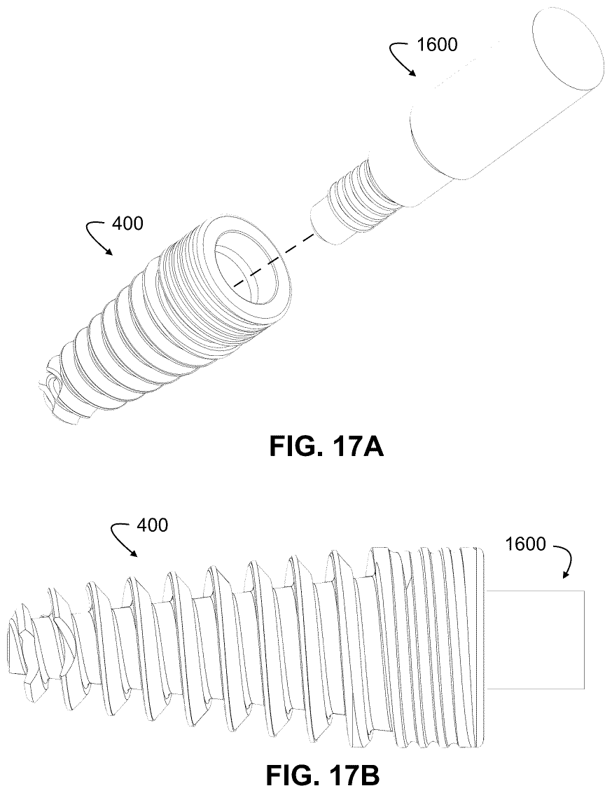

FIG. 17A is an exploded perspective view of a fastener body 400 and an abutment 1600 according to an embodiment of the present disclosure. FIG. 17B is a side view of the fastener body 400 assembled with the abutment 1600. The abutment 1600 may be received in the fastener body 400. The post portion 1620 may extend beyond the proximal end 401 of the fastener body 400, with the abutment 1600 secured to the fastener body 400. The post portion 1620 may provide a post and/or an anchor point for a dental crown 1800 (as shown in FIGS. 18A & 18B), a dental bridge, and/or another prosthetic dental component.

FIG. 18A is a perspective view of a fastener body 400 assembled with a dental crown 1800 according to an embodiment of the present disclosure. FIG. 18B is a side view of the fastener body 400 assembled with the dental crown 1800. The dental crown 1800 may be received on the abutment 1600. More specifically, the dental crown 1800 may be received on the post portion 1620 of the abutment 1600.

Alternatively, the dental crown 1800 may include a post that is received in the fastener body 400 without an abutment. The post may be secured to the fastener body 400 using cement, adhesive, and/or a mechanical connection.

The material(s) of any portion of a bone implant, joint replacement implant, fastener, bone disunion fastener, etc., described herein may include, but are not limited to: metals (e.g., titanium, cobalt, etc.), metal alloys (stainless steel, titanium alloy, nickel-titanium alloy, etc.), plastics, polymers, ceramics, PEEK, UHMWPE, composites, additive particles, textured surfaces, biologics, biomaterials, bone, etc.

A fastener body may be one of a set of fasteners each having a different thread option described or contemplated herein. A surgical kit may include multiple fasteners/implants with any of the different fasteners/implants and thread options described or contemplated herein. A surgeon may select the appropriate fasteners/implants from the kit based on the particular loads to be applied and/or the quality of bone in which the fastener/implants are to be anchored.

It will be understood that any fastener/implant described or contemplated herein may include any thread configuration, feature, or morphology described or contemplated herein to achieve optimal fixation within a given bone/tissue. Moreover, it will also be understood that any fastener/implant described or contemplated herein may be utilized in conjunction with (or within) any system, method, or instrumentation described or contemplated herein.

Any of the fasteners described herein may be configured for removal and replacement during a revision procedure by simply unscrewing and removing the fastener from the bone/tissue in which the fastener resides. Moreover, the fasteners described herein may advantageously be removed from bone without removing any appreciable amount of bone during the removal process to preserve the bone. In this manner, fasteners may be mechanically integrated with the bone, while not being cemented to the bone or integrated via bony ingrowth, in order to provide an instant and removable connection between a fastener and a bone. Accordingly, revision procedures utilizing the fasteners described herein can result in less trauma to the bone and improved patient outcomes.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the present disclosure. This method of disclosure, however, is not to be interpreted as reflecting an intention that any embodiment requires more features than those expressly recited in that embodiment. Rather, inventive aspects lie in a combination of fewer than all features of any single foregoing disclosed embodiment.

Recitation of the term “first” with respect to a feature or element does not necessarily imply the existence of a second or additional such feature or element. Elements recited in means-plus-function format are intended to be construed in accordance with 35 U.S.C. § 112(f). It will be apparent to those having skill in the art that changes may be made to the details of the above-described embodiments without departing from the underlying principles set forth herein.

The phrases “connected to,” “coupled to,” “engaged with,” and “in communication with” refer to any form of interaction between two or more entities, including mechanical, electrical, magnetic, electromagnetic, fluid, and thermal interaction. Two components may be functionally coupled to each other even though they are not in direct contact with each other. The term “coupled” can include components that are coupled to each other via integral formation, as well as components that are removably and/or non-removably coupled with each other. The term “abutting” refers to items that may be in direct physical contact with each other, although the items may not necessarily be attached together. The phrase “fluid communication” refers to two or more features that are connected such that a fluid within one feature is able to pass into another feature. Moreover, as defined herein the term “substantially” means within +/−20% of a target value, measurement, or desired characteristic.

While specific embodiments and applications of the present disclosure have been illustrated and described, it is to be understood that the scope of this disclosure is not limited to the precise configuration and components disclosed herein. Various modifications, changes, and variations which will be apparent to those skilled in the art may be made in the arrangement, operation, and details of the devices, systems, instruments, and methods disclosed herein.

1. A threaded dental implant comprising:
a fastener body defining a longitudinal axis, the fastener body comprising:
a proximal end comprising an internal pocket configured to receive a dental component; and
a distal end; and
a helical thread disposed about the fastener body and extending along the longitudinal axis, the helical thread comprising a major thread diameter, a minor thread diameter, a distal-facing side and a proximal-facing side;
wherein:
the minor thread diameter is tapered such that the minor thread diameter is smaller at the distal end than at the proximal end; and
the helical thread comprises a first thread form comprising a generally concave side.

2. The threaded dental implant of claim 1, wherein the distal-facing side is generally concave and the proximal-facing side is generally convex.

3. The threaded dental implant of claim 1, wherein the major thread diameter is tapered such that the major thread diameter is smaller at the distal end than at the proximal end.

4. The threaded dental implant of claim 1, wherein a first portion of the helical thread, proximate the proximal end, comprises the major thread diameter that is generally constant and the minor thread diameter that is generally constant.

5. The threaded dental implant of claim 1, wherein a first portion of the helical thread, proximate the proximal end, comprises a second thread form lacking the generally concave side.

6. The threaded dental implant of claim 4, wherein the first portion of the helical thread, proximate the proximal end, comprises the first thread form and a second portion of the helical thread, proximate the distal end, comprises a second thread form that is generally equal to the first thread form.

7. The threaded dental implant of claim 6, wherein the fastener body comprises a cutting flute extending from the distal end to the proximal end.

8. The threaded dental implant of claim 1, wherein the helical thread extends from the distal end to the proximal end.

9. The threaded dental implant of claim 1, wherein the fastener body comprises a tapered lead-in portion proximate the distal end.

10. The threaded dental implant of claim 9, wherein the tapered lead-in portion lacks the helical thread.

11. The threaded dental implant of claim 9, wherein the tapered lead-in portion comprises a second thread form lacking the generally concave side.

12. The threaded dental implant of claim 1, wherein the proximal end comprises a threaded socket configured to receive the dental component.

13. The threaded dental implant of claim 1, wherein the distal portion comprises a second helical thread comprising a thread form lacking a concave side and the proximal portion comprises a third helical thread comprising a micro-thread form.

14. A threaded dental implant comprising:
a fastener body defining a longitudinal axis, the fastener body comprising:
a proximal end comprising an internal pocket configured to receive a dental component;
a distal end;
a first portion comprising a first helical thread disposed about the first portion along the longitudinal axis and comprising a first thread form; and
a second portion comprising a second helical thread disposed about the second portion along the longitudinal axis and comprising a second thread form;
wherein:
the first thread form comprises a distal-facing side that is generally concave and a proximal-facing side that is generally convex; and
the second thread form lacks a generally concave side.

15. The threaded dental implant of claim 14, wherein the second helical thread comprises a major thread diameter and a minor thread diameter that is tapered.

16. The threaded dental implant of claim 14, wherein the first helical thread comprises a major thread diameter that is generally constant and a minor thread diameter that is generally constant.

17. The threaded dental implant of claim 14, wherein the second portion further comprises a tapered lead-in portion comprising the second thread form.

18. The threaded dental implant of claim 17, wherein the fastener body further comprises a third portion, proximate the proximal end, comprising a third helical thread disposed about the third portion along the longitudinal axis and comprising a third thread form lacking the generally concave side.

19. The threaded dental implant of claim 18, wherein the third thread form is a micro-thread form.

20. A threaded dental implant comprising:
a fastener body defining a longitudinal axis, the fastener body comprising:
a proximal end comprising an internal pocket configured to receive a dental component;
a distal end;
a first portion comprising a first helical thread disposed about the first portion along the longitudinal axis and comprising a first thread form;
a second portion comprising a second helical thread disposed about the second portion along the longitudinal axis and comprising a second thread form; and
a cutting flute extending from the distal end to the proximal end;
wherein:
at least one of the first thread form and the second thread form comprises a distal-facing side that is generally concave and a proximal-facing side that is generally convex.

21. The threaded dental implant of claim 20, wherein the first helical thread comprises a first major thread diameter that is generally constant and a first minor thread diameter that is generally constant; and the second helical thread comprises a second major thread diameter and a second minor thread diameter that is tapered.

22. The threaded dental implant of claim 20, wherein the second portion extends from the first portion to the distal end, and the second portion comprises the second thread form comprising the distal-facing side that is generally concave and the proximal-facing side that is generally convex.
